(19) United States
(12) Patent Application Publication
(10) Pub. No.: US 2018/0096410 A1
(43) Pub. Date: Apr. 5, 2018

(54) Method and Apparatus for Providing Matching Information of Business Object

(71) Applicant: Alibaba Group Holding Limited, Grand Cayman (KY)

(72) Inventors: Peng Zhao, Hangzhou (CN); Ying Wang, Hangzhou (CN); Lijun Zhu, Hangzhou (CN); Zhenhua Zhu, Hangzhou (CN); Xinyang Cui, Hangzhou (CN); Heng Liu, Hangzhou (CN)

(21) Appl. No.: 15/822,012

(22) Filed: Nov. 24, 2017

Related U.S. Application Data
(63) Continuation of application No. PCT/CN2016/080013, filed on Apr. 22, 2016.

(30) Foreign Application Priority Data
May 25, 2015 (CN) 201510272351.2

(51) Int. Cl. G06Q 30/06; G06F 17/30

(52) U.S. Cl. CPC G06Q 30/0631; G06F 17/30867; G06Q 30/0643

(57) ABSTRACT

Methods and apparatuses for providing matching information of a business object are disclosed in the embodiments of the present disclosure. A method includes pre-establishing a matching information database of business objects of a fashion category by a server, the matching information database storing respective one or more matching proposals corresponding to first business objects, and the matching proposals including respective second business objects that matches with the first business objects and corresponding matching degree information; receiving a request for obtaining matching information of a specific first business object from a first user client; and providing information of a matching proposal of the specific first business object according to the matching information database. The embodiments of the present disclosure can save resources used by user operations such as switching between categories, and help reducing the access pressure and workload of a server.

### CROSS REFERENCE TO RELATED PATENT APPLICATIONS

This application claims priority to and is a continuation of PCT Patent Application No. PCT/CN2016/080013 filed on 22 Apr. 2016, and is related to and claims priority to Chinese Patent Application No. 201510272351.2, filed on 25 May 2015, entitled “Method and Device for Providing Business Object Collocation Information,” which are hereby incorporated by reference in their entirety.

### TECHNICAL FIELD

The present disclosure relates to the technological field of processing information of business objects, and particularly to methods and apparatuses for providing matching information of a business object.

### BACKGROUND

A number of different categories of business objects exist in an e-commerce sales platform. One of the main categories is a category related to fashion. Fashion is a generic term for ornaments of a human body, which includes clothes, shoes, hats, socks, gloves, scarves, ties, handbags, umbrellas, hair accessories, etc. In daily life, products belonging to the fashion category generally possess characteristics of matching and using with one another. However, the number of products for sales in the e-commerce sales platform is tremendous. After selecting a product of the fashion category, a buyer generally finds it relatively difficult to select other clothes that have a good matching effect with the product from among the tremendous number of products, because of the inability of viewing products in an actual form. On the other hand, after a buyer buys a product, a seller or a merchant user always desires him/her to buy other products that can match and be used with the product at the same time, which is called a “link order”, to improve sales volume thereof.

In existing technologies, some e-commerce sales platforms provide a “fitting” function to users for the purpose of helping the users to view matching effects. A user can upload an image thereof, or select a model having a size and a shape similar to him/her from models provided by a system. During a process of selecting a business object of a fashion category, the user can dress up the model with selected clothes, to display a matching effect of the clothes. However, this selection process requires the user to switch among different categories, and thus is relatively tedious. Furthermore, selected objects that can be browsed by the user are limited in number, and some good products may be left out merely because they are not browsed by the user and thus not selected for matching. From the perspective of a system, user operations, such as repeatedly switching among different categories, can cause a waste of system resources, and increase the workload and the access pressure of a server.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The present disclosure provides a method and an apparatus for providing matching information of a business object, which can save resources due to user operations such as switching among categories, and help to reduce the access pressure and the workload of a server.

The present disclosure provides the following solutions.

A method for establishing a matching information database of business objects, includes determining at least one second business object that is selectable when matching a first business object; determining at least one information dimension that is referable when matching the first business object; determining matching degree information between the second business object and the first business object based on respective property information of the second business object and the first business object with respect to a corresponding dimension; and generating and storing at least one matching proposal corresponding the first business object in the matching information database, the matching proposal including a second business object that matches the first business object and corresponding matching degree information.

A method for providing matching information of a business object, includes pre-establishing a matching information database of business objects of a fashion category by a server, the matching information database storing respective one or more matching proposals corresponding to first business objects, and the matching proposals including respective second business objects that matches with the first business objects and corresponding matching degree information; receiving a request for obtaining matching information of a specific first business object from a first user client; and providing information of a matching proposal of the specific first business object according to the matching information database.

A method for providing matching information of a business subject, includes receiving a request for obtaining matching information of a specific first business object by a client of a first user; transmitting the request to a server, to enable the server to return matching proposal information of the specific first business object according to a pre-established matching information database, wherein the matching information database stores at least one matching proposal of the first business object, and the matching proposal includes a second business object that matches the first business object and matching degree information; and providing the matching proposal information of the specific first business object according to response information returned from the server.

A method for providing matching information of a business object, includes receiving a request for obtaining matching information of a specific first business object from a first user client by a server; determining at least one second business object that is selectable when the first business object is matched; determining at least one information dimension that is referable when the first business object is matched; determining matching degree information between the second business object and the first business object based on respective property information of the second business object and the first business object on a corresponding dimension; and providing matching proposal information of the specific first business object based on the matching degree information.

A method for providing matching information of a business object, includes a first user client receiving a request for obtaining matching information of a specific first business object; transmitting the request to a server, to enable the server to determine at least one second business object that is selectable when the first business object is matched, determine at least one information dimension that is referable when the first business object is matched, determiner matching degree information between the second business object and the first business object based on respective property information of the second business object and the first business object on a corresponding dimension, and provide matching proposal information of the specific first business object based on the matching degree information; and providing the matching proposal information of the specific first business object according to response information returned from the server.

An apparatus for establishing a matching information database of business objects, includes a selectable business object determination unit used for determining at least one second business object that is selectable when matching a first business object; an information dimension determination unit used for determining at least one information dimension that is referable when matching the first business object; a matching degree determination unit used for determining matching degree information between the second business object and the first business object based on respective property information of the second business object and the first business object on a corresponding dimension; and a matching proposal generation unit used for generating at least one matching proposal corresponding the first business subject, and storing thereof in the matching information database, the matching proposal including a second business object that matches the first business object and corresponding matching degree information.

An apparatus for providing matching information of a business object, which is applied in a server, includes a database creation unit used for establishing a matching information database of business objects of a fashion category in advance, the matching information database storing at least one matching proposal corresponding to a first business object, and the matching proposal including a second business object that matches with the first business object and corresponding matching degree information; a request receiving unit used for receiving a request for obtaining matching information of a specific first business object from a first user client; and a matching proposal provision unit used for providing information of a matching proposal of the specific first business object according to the matching information database.

An apparatus for providing matching information of a business subject, which is applied in a first user client, includes a first matching request receiving unit used for receiving a request for obtaining matching information of a specific first business object; a first request transmission unit used for transmitting the request to a server, to enable the user to return of matching proposal information of the specific first business object according to a pre-established matching information database, wherein the matching information database stores at least one matching proposal of the first business object, and the matching proposal includes a second business object that matches the first business object and matching degree information; and a matching proposal provision unit used for providing the matching proposal information of the specific first business object according to response information returned from the server.

An apparatus for providing matching information of a business object, which is applied in a server, includes a request receiving unit used for receiving a request for obtaining matching information of a specific first business object from a first user client; a business object determination unit used for determining at least one second business object that is selectable when the first business object is matched; an information dimension determination unit used for determining at least one information dimension that is referable when the first business object is matched; a matching degree information determination unit used for determining matching degree information between the second business object and the first business object based on respective property information of the second business object and the first business object on a corresponding dimension; and a matching proposal determination unit used for providing matching proposal information of the specific first business object based on the matching degree information.

An apparatus for providing matching information of a business object, which is applied in a first user client, includes a second matching request receiving unit used for receiving a request for obtaining matching information of a specific first business object; a second matching request transmission unit used for transmitting the request to a server, to enable the server to determine at least one second business object that is selectable when the first business object is matched, determine at least one information dimension that is referable when the first business object is matched, determiner matching degree information between the second business object and the first business object based on respective property information of the second business object and the first business object on a corresponding dimension, and provide matching proposal information of the specific first business object based on the matching degree information; and a second matching proposal provision unit used for providing the matching proposal information of the specific first business object according to response information returned from the server.

According to the exemplary embodiments provided in the present disclosure, the present disclosure discloses the following technical advantages.

Using the embodiments of the present disclosure, a matching proposal can be automatically recommended for a first business object selected by a user. This helps a buying user to select second business object(s) having a relatively good matching effect with a first business object selected by him/her, without performing operations such as frequent switching between categories. From the perspective of a system, this saves resources used by user operations such as switching between categories, and helps reducing the access pressure and workload of a server.

Apparently, any product implementing the present disclosure does not need to achieve all of the above advantages at the same time.

### BRIEF DESCRIPTION OF THE DRAWINGS

In order to clearly describe technical solutions of the embodiments of the present disclosure or the existing technologies, accompanying drawings that are needed for describing the embodiments are briefly described herein. Apparently, the described drawings merely represent some embodiments of the present disclosure. Based on these accompanying drawings, one of ordinary skill in the art can obtain other drawings without making any creative effort.

FIG. 1 is a flowchart of a first example method in accordance with the present disclosure.

FIG. 2 is a flowchart of a second example method in accordance with the present disclosure.

FIGS. 3-1-3-6 are schematic diagrams of a user interface in accordance with the present disclosure.

FIG. 4 is a flowchart of a third example method in accordance with the present disclosure.

FIG. 5 is a flowchart of a fourth example method in accordance with the present disclosure.

FIG. 6 is a flowchart of a fifth example method in accordance with the present disclosure.

FIG. 7 is a flowchart of a sixth example method in accordance with the present disclosure.

FIG. 8 is a flowchart of a seventh example method in accordance with the present disclosure.

FIG. 9 is a schematic diagram of a first example apparatus in accordance with the present disclosure.

FIG. 10 is a schematic diagram of a second example apparatus in accordance with the present disclosure.

FIG. 11 is a schematic diagram of a third example apparatus in accordance with the present disclosure.

FIG. 12 is a schematic diagram of a fourth example apparatus in accordance with the present disclosure.

FIG. 13 is a schematic diagram of a fifth example apparatus in accordance with the present disclosure.

FIG. 14 is a schematic diagram of a sixth example apparatus provided the present disclosure.

FIG. 15 is a schematic diagram of a seventh example apparatus in accordance with the present disclosure.

### DETAILED DESCRIPTION

The technical solutions of the embodiments of the present disclosure are described in a clear and comprehensive manner in conjunction with the accompanying drawings of the embodiments of the present disclosure. Apparently, the described embodiments merely represent some and not all of the embodiments. Based on the embodiments in the present disclosure, all the other embodiments that are obtained by one of ordinary skill in the art should fall in the scope of protection of the present disclosure.

In the embodiments of the present disclosure, in order to help a user to select business objects of a fashion category that have a good matching effect, or to promote a completion of a “link” order, for a first business object selected by a user, a second business object having a relatively good matching effect with such business object can be provided. In implementations, a client-server mode may be implemented. For example, a server may first establish a matching information database, and for first business objects, store at least one second business object that can match a respective first business object in the database. As such, in response to receiving a matching request of a user, a client can obtain a corresponding matching proposal and provide thereof to the user through the server that performs a query in the database.

Apparently, when matching fashion category products, clothes of different types can be matched and used together in theory. For example, a category of socks has 100 pieces of socks, and a category of jackets has 100 pieces of jackets, leading to 10000 matching combinations in theory. However, in real implementations, such large number of matching combinations, which amounts to no recommendation, cannot be recommended to a user apparently. Furthermore, in reality, matching is not arbitrary in the aspect of fashion matching. For example, what types of socks match what types of shirts, shoes, etc., have issues to consider. Colors, materials, designs, styles, etc., need to be considered, and cannot be matched arbitrarily. Therefore, how to enable a system to automatically recommend a business object that has a good matching effect with another business object to facilitate establishing a matching information database as described in the foregoing is an important problem needed to be considered. A method for establishing this database is first described herein.

### First Embodiment

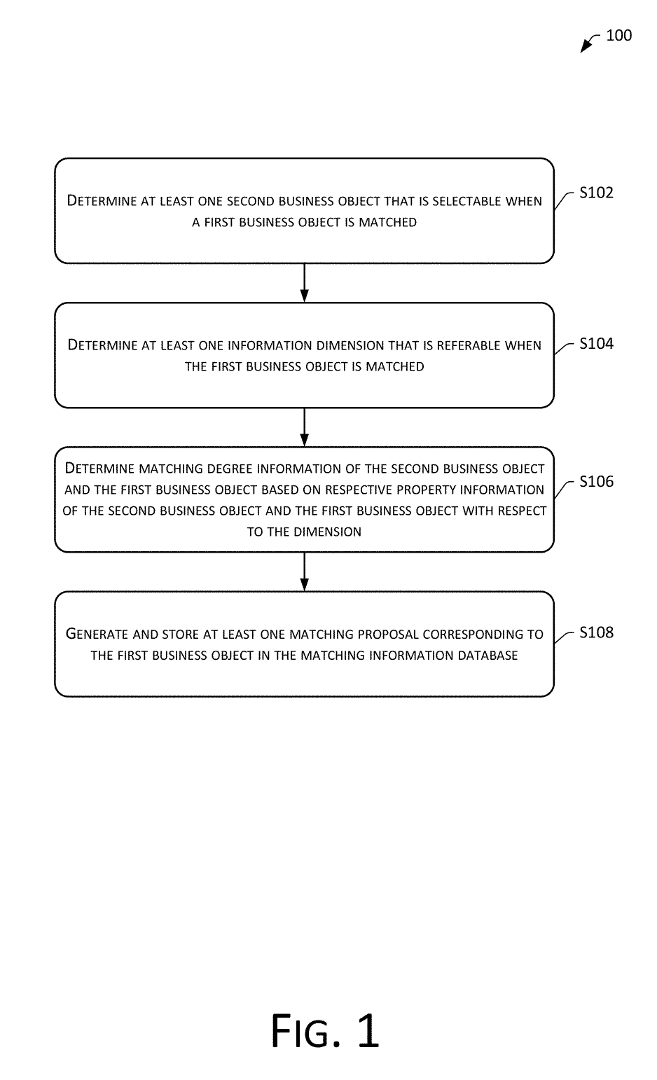

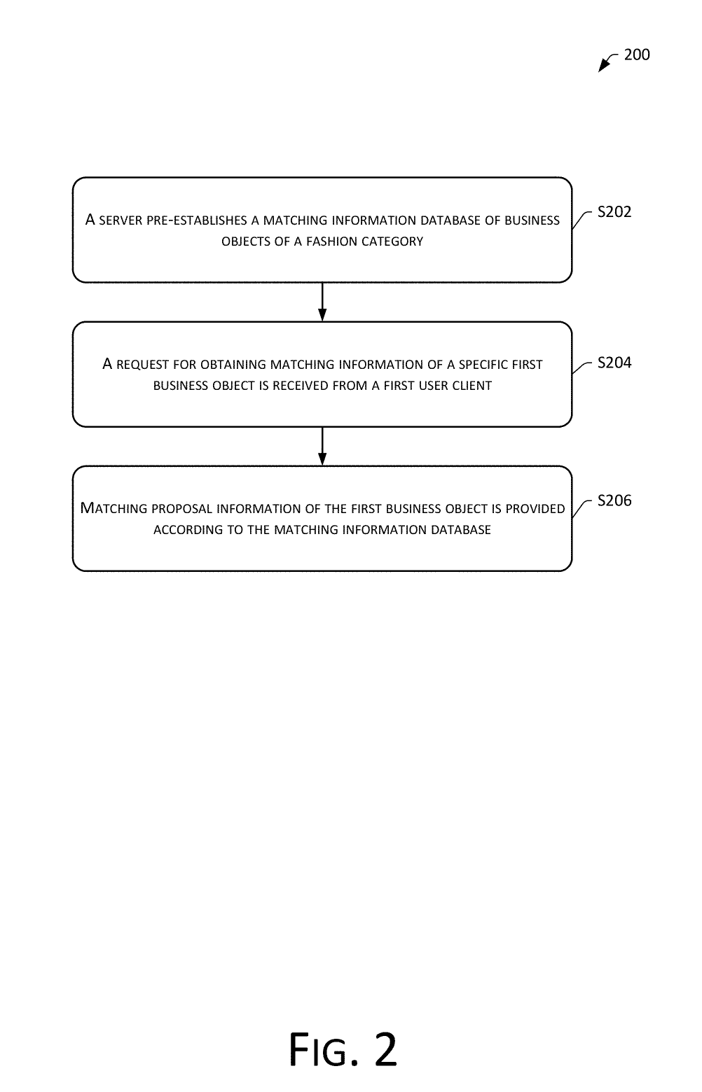

Referring to FIG. 1, the first embodiment provides a first example method 100 for establishing a matching information database of business objects. The method 100 may include the following operations.

S102 determines at least one second business object that is selectable when a first business object is matched.

The first business object and the second business object are business objects of a fashion category. For a first business object, when selecting second business object(s) that can be matched therewith, a number of selectable second business objects may first be determined. A number of different types of methods may exist. For example, at least one second business object can be determined from matchable target categories based on preset category matching information and a category to which the first business object belongs. In other words, for fashion matching, matching objects may first be selected from the large side (i.e., the perspective of categories). For example, if the first business object belongs to a category of socks, a matching target category can include a category of shirts, a category of shoes, etc. Moreover, if a more refined category can be determined, a determined target category can be more refined. For example, if the first business object belongs to a category of short pants, a category matching therewith can be a category of t-shirts, a category of sandals, etc.

It should be noted that, when the embodiments performs recommendation of a matching proposal, this can be performed in a same store, i.e., the second business object that is recommended belongs to the same category as the first business object. Alternatively, matching recommendation can be performed across stores, i.e., matching can be performed between a first business object of a first store and a second business object of a second store. In implementations, a second business object can be matched from a selection in a same store or a selection across different stores based on an actual requirement. In other words, when a first business object is matched, at least one second business object that is selectable includes other business objects belonging to a same store of the first business subject, or business objects of other stores.

S104 determines at least one information dimension that is referable when the first business object is matched.

In implementations, a referable information dimension may include a dimension related to specification parameters of a business object thereof, which includes the first business object's color, materials, design, style, whether including a certain fashion element, price, etc., and may also include matching object(s) that has/have been known to match the first business object previously. In other words, the first business object has been matched with some other business objects before. In other words, a first business object can correspond to a set of matching objects. Each matching object in the set has been matched to the first business object by a user or a merchant. As this type of historical matching information exists objectively, it can be considered as a type of property of the first business object. This information possesses a certain reference value when determining a matching degree, and therefore can be used as an information dimension that is referable. In implementations, a factor of specification parameters of a business object and a factor of historical matching information can be considered together, to determine a degree of matching between a certain second business object and a first business object in a comprehensive manner.

With respect to information of specification parameters related to a business object, a second user (which includes a seller, a merchant, etc.) usually submits information of specification parameters of business objects when publishing information of the business objects, to allow a presentation thereof to first users (which are generally referred to a buying users) in respective details pages of the business objects. Correspondingly, a server records this type of specification parameter information. Therefore, this type of specification parameter information can be obtained directly from a record of the server.

With respect to historical matching information, a number of different types of sources may exist. For example, according to a type of method, a sales platform may record historical activity records of users, which include past purchase records, collection records, browsing records, etc. Based on data of these types of historical activity records, a determination can be made as to whether a first target user who performs a preset operation on a first business object A performs the preset operation on a certain business object B within a preset time period of the preset operation on the first business object A, and whether a category to which the business object B belongs has a matching relationship with a category to which the business object A belongs. If affirmative, this may be because the first user needs to perform a matching between the business object B and the business object A. Apparently, in order to avoid a false-positive, after determining that the business object B fulfills this type of requirement, a clustering may also be performed based on a large amount of user data, and a further determination may be made as to whether the business object B can be used for matching with the first business object A. For example, a determination may be made as to whether the above situation exists in historical activity records of a number of users. In this way, a first set of matching objects can be obtained for the first business object A. Each business object in the set is determined as a matching object that is previously selected for the first business object by a first user.

Furthermore, this type of historical matching information may also be obtained from exemplary matching proposals. A variety of different exemplary matching proposals may exist. For example, a commonly seen situation is to provide some matching information to a user when a second user publishes a product. For example, a business object of a certain user includes both a first business object and a second business object. When detailed information of the first business object is provided, a recommendation for matching and purchasing the second business object may be made, for example.

Moreover, some images generally exist in a network. These images may be uploaded by merchants, or may be uploaded by buyers who show their matching results, etc. In short, these images generally include exemplary matching proposals. For example, a model may wear a set of clothes that have a good match, etc. Therefore, this type of image may also undergo an image analysis in advance, to determine which business objects in a sales platform correspond to various single items in the image. In other words, identifiers of business objects corresponding to single items that form this matching proposal are individually recognized from the image. Apparently, in a real application, after individually determining identifiers of business objects corresponding to single items for a same image, business objects having same or similar designs/styles of the single items are also determined. A plurality of exemplary matching proposals may then be formed based on the identifiers of the business objects corresponding to the single items and identifiers of the business objects having same or similar designs/styles of the single items.

In short, a set of second matching objects can be determined for a first business object using this type of exemplary matching proposal. Each business object in the set is a matching object that is used for matching the first business object in the exemplary matching proposal.

It should be noted that referable information dimensions may have different individual weights. For example, a weight of an information dimension for matching objects obtained in exemplary matching proposals may be higher, and a weight for matching objects obtained from historical activity records may be lower because of an existence of a potential error and an uncertainty of whether a matching proposal made by an ordinary user has a good effect, for example. Furthermore, as described in the foregoing description, various selectable second business objects determined at S102 may separately belong to different target categories. Referable information dimensions and respective weights when the first business object is matched may be different for different categories. For example, the first business object is jeans, and second business object(s) that is/are determined may include a category of jackets, and/or a category of T-shirts, etc. For a business object of the category of jackets, primary reference dimension(s) may include a color, a style, etc. For a business object of the category of T-shirts, primary reference dimension(s) may include a design (high waist or low waist, etc.), for example.

S106 determines matching degree information of the second business object and the first business object based on respective property information of the second business object and the first business object with respect to the dimension.

Specifically, when determining the matching degree information of the second business object and the first business object, respective degree(s) of matching therebetween with respect to the dimension(s) is/are calculated, and the respective degree(s) with respect to the dimension(s) is/are summed to obtain final matching degree information.

Specifically, when determining the degree of matching with respect to the dimension of specification parameters, matching rules are individually set for the specification parameters. In this way, degree(s) of matching between the second business object and the first business object with respect to the dimension(s) can be determined individually, and the matching degree information of the second business object and the first business object can be determined by summing up the degree(s) of matching between the second business object and the first business object with respect to the dimension(s).

The matching rules may include positive rule(s) and mutual exclusive rule(s). A positive rule is used for representing a target specification parameter value that is allowed to match with a certain specification parameter value under a specific dimension. A mutual exclusive rule is used for representing a target specification parameter value that is not allowed to match with a certain specification parameter value under a specific dimension. For example, in a dimension of color, a positive rule may include:

Red color matches white color, black color, blue-grey color, cream, grey color

Pink matches purple-red color, black color, grey color, dark green color, white color, cream color, brown color, navy blue color

Coffee color matches cream color, light yellow color, brick red color, blue-green color, black color

Blue color matches white color, powder blue color, deep red color, golden color, silver color, olive-green color, orange color, yellow color

. . .

A mutual exclusive rule may include:

Deep green color matches deep blue color, deep red color

Powder red color matches red color

. . .

In this way, when a degree of matching between a second business object and a first business object is calculated with respect to a dimension of color, a determination can be made according to the above rules. For example, the first business object is blue in color, and a certain second business object is white in color, and satisfies a positive rule on the dimension of color. Therefore, a score of this second business object with respect to the dimension of color is relatively high, for example.

Other dimensions can be processed in a similar manner. As such, corresponding degrees of matching can be separately determined with respect to the various dimensions.

In implementations, in order to help determining a comprehensive degree of matching, respective degrees of matching with respect to various dimensions may be individually assigned scores. For example, with respect to the color dimension, if a certain second business object satisfies a positive rule, a score of one is added. If a mutual exclusive rule is satisfied, a score of two is deducted. Processing for other dimensions of specification parameters is performed in a similar manner. With respect to a dimension of historical matching records, if a certain second business object appears in a historical matching record set of the first business object, a score of one is added. Otherwise, a score of two is deducted, for example. In this way, a comprehensive degree of matching between the second business object and the first business object can finally be calculated.

S108 generates and stores at least one matching proposal corresponding to the first business object in the matching information database. The matching proposal includes the selectable second business object that matches the first business object, and the matching degree information.

After determining respective degrees of matching between second business objects and the first business object, at least one matching proposal related to the first business object can be determined. For example, the second business objects can be ranked according to a descending order of the respective degrees of matching. A predetermined number of highest ranked second business objects are determined as business objects having a relatively good matching effect with the first business object, and are stored as a matching proposal in the matching information database. For example, in an implementation, a structure of the matching information database may be shown in Table 1 as follows:

TABLE 1

| First business object ID | Second business object ID |
|---|---|
| Business object A | Business object 1, business object 2 . . . |
| Business object B | Business object 3, business object 4 . . . |
| Business object C | Business object 5, business object 6 . . . |
| . . . | . . . |

The matching degree information of the second business objects and the first business object can be implicitly included in the above Table 1 by means of ranking, or may be stored explicitly. For example, a result of the database may be shown in Table 2 as follows:

TABLE 2

| | | Matching |
|---|---|---|
| First business object ID | Second business object ID | degree |
| Business object A | Business object 1 | D1 |
| Business object B | Business object 2 | D2 |
| Business object C | Business object 3 | D3 |
| . . . | . . . | . . . |

It should be noted that a situation in which a same type of business object appears in different stores in a sales platform usually exist, i.e., a same first business object may exist. Matching proposal determined for the same business objects can apparently be the same. Furthermore, some business objects, though being not the same, are similar, and matching proposals thereof may be the same or similar. Therefore, in order to avoid an occurrence of redundant calculation, a determination may be made as to whether the matching information database includes matching proposal(s) corresponding to business object(s) that is/are same as or similar to the first business object prior to S102. If affirmative, the calculation does not need to be repeated. Otherwise, S102 and operations thereafter are performed.

After determining various matching proposals of the first business object, respective property tags may be individually determined for the matching proposals. These property tags can be used for describing one or more items of the following items: a style (formal, leisure, etc.) of a corresponding matching proposal, a price, a suitable occasion to wear (work, gathering, outdoor activities, etc.), a group (possibly divided into groups based on ages, etc.), etc. The property tags may be added by a technical person according to respective single items. Alternatively, a first user may assign a tag for a matching proposal after the matching proposal is provided to the first user. A server may arrange and add the tag to the matching information database for storage, for example. This type of property tag helps a second user to obtain a matching property that is desired by him/her.

Furthermore, the matching information database may also store identifiers of stores to which single items in a matching proposal respectively belong. As such, in a subsequent process of recommending a matching proposal, filtering and selection may also be performed on matching proposal based on this type of store identifier information if recommendation within a store is needed. Apparently, in a real application, an individual matching database may also be separately established for each store if necessary. Details of calculating a degree of matching may be the same as the one described in the foregoing text, and a difference therebetween is that second business objects that are selectable are determined from a same store.

Moreover, the matching information database may further store information of respective categories to which various second business objects belong. In this way, recommended matching proposals may be provided according to categories when being provided to the first user at a later stage. For example, a list of selectable categories may be provided to the first user. After the user selects a certain category, only a matching proposal corresponding to the category is provided to the first user, for example.

Under a situation where information such as property tags, stores, categories, etc., is stored, a structure of matching information data may be shown in Table 3 as follows:

TABLE 3

| | | | | Store to | Store to | Category |
|---|---|---|---|---|---|---|
| | | | | which the | which the | to which |
| | | | | first | second | the second |
| First | Second | | | business | business | business |
| business | business | Degree of | Property | object | object | object |
| object ID | object ID | matching | tags | belongs | belongs | belongs |
| Business | Business | D1 | Suitable | Store 1 | Store 2 | Jacket |
| object A | object 1 | | for | | | |
| | | | outdoor | | | |
| | | | activities, | | | |
| | | | aged | | | |
| | | | between | | | |
| | | | 20 and 29 | | | |
| . . . | . . . | . . . | . . . | . . . | . . . | . . . |

After establishing the matching information database, matching proposals may be provided to second users according to the database. In this process, the efficiencies of using the matching proposals by the second users may further be calculated, and respective degrees of matching corresponding to the matching proposals in the matching information database may be adjusted. A variety of different ways about how to determine whether a certain matching proposal is effectively used may exist. For example, after the system recommends a certain matching proposal to a certain first user, the matching proposal may be considered to be effectively used once if the first user performs an operation such as saving in a collection or making a purchase for the matching proposal. Alternatively, some “expert” users may be recommended by second user(s) and the sales platform. The expert users are users having relatively strong experience with respect to fashion matching. These expert users can select matching proposals that they believe to be better from among a number of different matching proposals for sharing, such as sharing to buddy users of these expert users, or other target users related thereto, for example. Operations of these users who receive such sharing with respect to the matching proposals are then monitored. For example, a certain expert user shares a certain matching proposal to a user A, and the user A saves this matching proposal or makes a purchase for a business object therein after receiving, this matching proposal is considered to be effectively used once, for example. In short, scores of degrees of matching of various matching proposals in the matching information database can further be adjusted using feedbacks about conditions of using the matching proposals by second users.

After establishing a matching information database using the above method provided in the first embodiment, matching information can be recommended and provided to a first user according to the database. A process of providing matching information is described in detail hereinafter.

### Second Embodiment

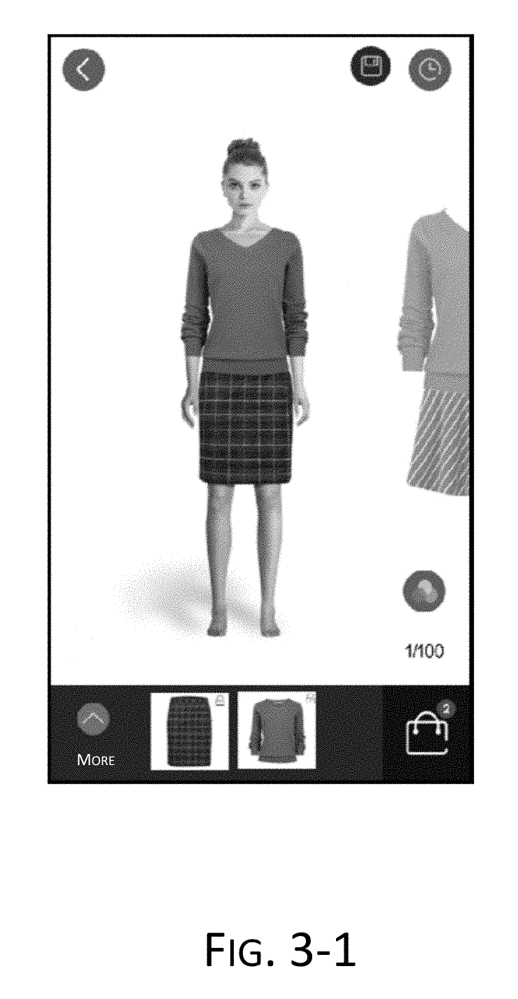

The second embodiment describes a method of implementing provision and recommendation of a matching proposal from the perspective of a server. Referring to FIG. 2, the second embodiment provides a second example method 200 for providing matching information of a business object. The method 200 may include the following operations.

At S202, a server pre-establishes a matching information database of business objects of a fashion category, the matching information database storing at least one matching proposal corresponding to a first business object, and the matching proposal including second business object(s) that is/are matchable with the first business object and matching degree information.

The server includes at least one first business object, and the first business object and the second business object(s) may be business objects of a fashion category. Details of a method of establishing the matching information database can be the one that is described in the first embodiment. Alternatively, in implementations, other methods of establishing a database may be used.

At S204, a request for obtaining matching information of a specific first business object is received from a first user client.

The first user client may provide a plurality of different entries used for entering into a “fitting room” function to a first user. An example is a detailed information page of a certain business object. In other words, after a user opens a detailed information page of a certain business object, an operation option used for entering into a “fitting room” function may be provided at a designated position of the page, and the user can enter into the “fitting room” via this option. An alternative is a home page of a store. In other words, after a user opens a home page of a certain store, an option of operation for entering into a “fitting room” may be provided at a designated position of the home page. Alternatively, an option of operation for entering into a “fitting room” may be provided at a designated position of a home page of a fashion channel. In other words, when a user just enters into a fashion channel and before selecting a specific store and a specific business object, an option of operation for entering into a “fitting room” is provided to the user. Moreover, a user may further save some business object in a collection. Business objects that have been saved in a collection may be displayed in a page displaying a collection list. These saved business objects may be business objects that the user has an intention of purchase but has not purchased yet. A reason why they have not been purchased may include a failure of finding other business objects that match these business objects. Therefore, an option of operation for entering into a “fitting room” may also be provided in the page displaying the collection list. Apparently, for business objects that have been purchased by a user, a need for purchasing other business objects matching therewith may exist. Therefore, an option of operation for entering into a “fitting room” may also be provided in a page of an order list of transaction. In short, in implementations, a number of different entries for entering into a “fitting room” may be provided to a user, to satisfy a matching need of the user in a variety of different situations.

After receiving a matching request from a first user, a client may transmit the request to a server. Therefore, the server may receive the request, and return a corresponding matching proposal to the client of the first user according to the request. In the embodiments of the present disclosure, the request is generally sent after the first user selects a certain first business object. Therefore, the request may include identification information of this specific first business object. Accordingly, after receiving the request, the server can provide a matching proposal corresponding to this specific first business object.

If the first user selects a certain business object and enters into a details page thereof to initiate a matching request, or initiates a matching request after selecting a certain business object in a page displaying a collection list, or initiates a matching request after selecting a certain business object in a page of an order list of transaction, the client may set the business object selected by the user as the specific first business object. Therefore, when submitting the matching request to the server, identification information of the business object selected by the user may be included in the request.

With respect to requests for entering a fitting room from a home page of a store and a home page of a fashion channel, as the first user has not selected a specific business object yet, a request for matching information may be a request for recommendation of some matching sets when the request is sent to the server. Apparently, a request from a home page of a store indicates that the first user may want to select something to match with from the store. In this case, identification information of the store may be included in the request. As such, after receiving the request, the server may recommend some matching proposals of “display window” related to the store to the first user. The “display window” may be designated by a merchant of the store, or may be automatically determined by the system based on information such as respective frequencies that the matching proposals are used.

With respect to a request from a home page of a fashion channel, this indicates that the first user may not have any clear restriction on stores, brands, etc. However, users generally perform a selection with a purpose. An example includes a need to select a matching set for attending a certain occasion, etc. Therefore, in order to enable recommended matching proposals meet a need of a first user, the user is requested to select or input property tag(s) of a matching proposal that is needed, including, for example, information such as a specific occasion. Apparently, the system may also obtain and know information such as user characteristics and/or preferences about fashion matching of the first user in advance, and determine property tags of matching proposals needed by the first user. In this way, the client may include information of property tags desired by the first user in the request. After receiving the request, the server can select matching proposal(s) satisfying these property tags from the matching information database, and return thereof to the client.

For the above two situations, after receiving recommended matching proposals, the client may provide the matching proposals to the first user. The first user may browse the matching proposals, and lock up a single item of interest when finding the single item of interest but desiring to change other single items. The single item that is locked may be considered as the specific first business object of the first user. A new request for obtaining matching information is sent to the server, and the request includes identification information of the specific first business object.

At S206, matching proposal information of the first business object is provided according to the matching information database.

After receiving the request from the client of the first user, various matching proposals corresponding to the specific first business object can be selected from the matching information database, and can be returned to the client of the first user. For example, if the specific first business object is A, second business objects that can match the first business object A are found to be 1, 2, 3, etc., by querying the matching information database. Information of these second business objects can therefore be returned to the client of the first user.

As described in the foregoing text, the first user can submit a request from a variety of different entries. For the server, requests from different entries amount to having different access sources. The server may provide different matching modes for requests from different access sources. Therefore, when providing matching proposal information of the specific first business object based on the matching information database, the matching information database may also determine an access source first, and select a specific matching mode based on the access source. Matching proposal information of the specific first business object is provided based on the matching mode and the matching information database.

For example, when the access source is a details page of the specific first business object or a home page of a store, matching and recommendation can generally be come from within the store because the user has selected this specific store. In this case, a corresponding first matching mode, i.e., selecting matching proposals from the store to which the first business object belong, may be used. When the matching proposal information of the specific first business object is provided based on the matching mode and the matching information database, a set of target matching proposals corresponding to the specific first business object may first be determined from the matching information database, and target matching proposal(s) of the same store may be selected from among the set of target matching proposals and provided to the client of the first user based on the first matching mode. The matching proposals of the same store refer to matching proposals having the first business object and second business objects belonging to the same store.

When the access source is a home page of a channel, a page of a collection list that includes the specific first business object or a page of an order list of transaction that includes the specific first business subject, matching and recommendation across stores may be performed because the first user may have no restriction or requirement on stores. In other words, a second matching mode may be used for providing matching proposals of stores to the first user. In this case, a set of target matching proposals corresponding to the specific first business object may be directly determined from the matching information database for providing to the client of the first user, without the need of distinguishing store information.

Apparently, preference information (style preference, brand preference, etc.) of different first users may be different when business objects are selected. For example, some first users like a simple style, some like a vintage style, some like certain specific brands, etc. Moreover, different first users have different purchasing powers, i.e., generally selecting prices in a certain range when making a purchase. Furthermore, information such as group(s) to which the first user belongs may also affect the first user to make a selection of business objects. Therefore, when matching proposals are provided to the first user, these pieces of personalized information of the first user may also be considered. For example, degrees of matching may similarly be calculated between the personalized information and the matching proposals with respect to various dimensions, and further selection or reordering may be performed on the matching proposals, for example.

In implementations, in the process of providing various matching proposals to the client of the first user, the server may further provide information of images displaying matching effects of the various matching proposals to the client of the first user. An image showing matching effect may include a human model, and the human model may wear the first business object and the second business object(s) in a respective matching proposal, to help presenting an effect of wearing thereof by the user.

A number of different methods exist for implementing the above provision of the images displaying matching effects. For example, in an implementation, a specialized image synthesis server may provide image processing services. This server can be another server internally deployed by the sales platform, or a third-party server having a cooperative relationship with the sales platform, for example. In implementations, respective second users (e.g., merchants) to which business objects belong may take pictures/videos of the business objects, for example, to obtain images having a stereo display effect. In other words, a business object displayed in an image can be captured in a state of being held up, and not a state of being laid down on a flat surface. In this way, when an image synthesis is performed, an effect that the clothes are worn on the model can be simulated. Furthermore, restrictions can also be made on a format, a size, etc., of an uploaded image. After performing processing such as unified normalization, liquefaction, etc., on stereo images corresponding to the business object, the image synthesis server can perform storing thereof. Alternatively, the stereo images of the business object can also be taken by professional persons of a service party that provides the image synthesis server. In this case, the merchants can provide real samples of the business objects to the service party, and the professional persons take pictures/videos thereof in unity. When storing image information, the image synthesis server can store mapping relationships between identifiers of the business objects and respective stereo images. Furthermore, certain association relationships between these identifiers and identifications such as ID of the corresponding business objects in the sales platform may exist. In this way, after determining matching proposals corresponding to the specific first business object, the server can determine identifiers of the first business object and the second business objects of the matching proposals in the image synthesis server, and send these identifiers to the image synthesis server. In response to receiving this information, the image synthesis server can obtain respective stereo images corresponding to the first business object and the second business objects from a pre-stored image database, and perform synthesis with a preconfigured human model image. In this way, a dress-up effect when matching a first business object and a second business object can be obtained. After obtaining synthesized images, the image synthesis server can return the synthesized images to the server of the sales platform. As such, the server of the sales platform can provide the synthesized images to the client of the first user, and the client of the first user can display various images of matching effects.

Alternatively, in another implementation, stereo images of business objects can also be stored in the server of the sales platform directly, and the client is enabled to possess an image synthesis function by providing a plug-in, for example, to the client. In this way, after determining matching proposals that can be recommended, the server can provide stereo images corresponding to the first business object and second business objects in the matching proposals to the client. The client can call the plug-in, and the plug-in uses the stereo images and preconfigured human model to synthesize images displaying matching effects.

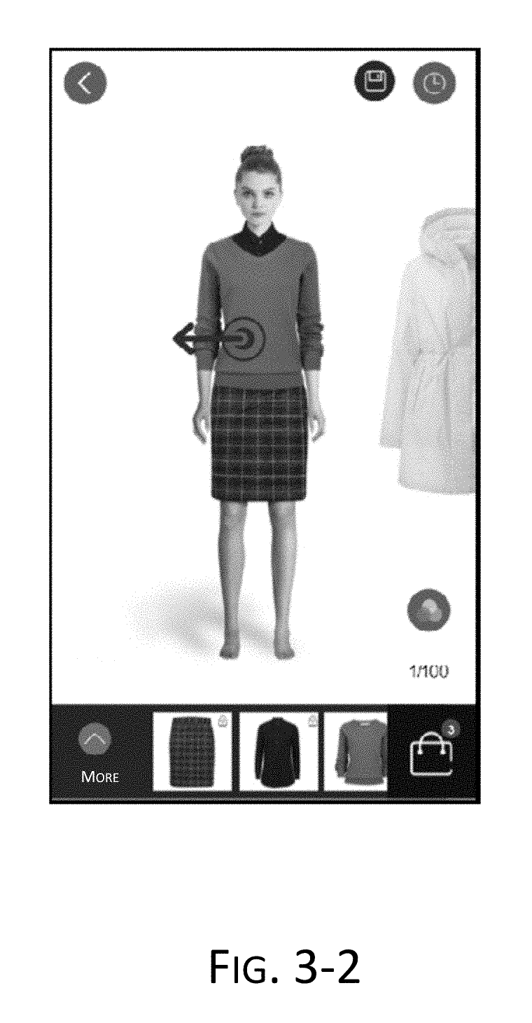

For example, when a certain first user enters a “fitting room” from a home page of a certain store, the user may be provided with “display window” matching proposals of the store. Referring to FIG. 3-1, an image showing a matching effect of a matching proposal may be displayed in a user interface, and a method for switching and viewing other proposals may also be provided. For example, images displaying matching effects of other matching proposals can be viewed by sliding to the left or right. Apparently, each single item on a model can be changed when sliding at this time, i.e., switching from a matching set to another matching set. It is because a user has not locked up any one of the single items. After a first user locks up a single item in a certain matching proposal, the server provides matching proposals that can match with this single item, and can provide images showing matching effects of the matching proposals in a similar manner. The user can switch and view matching effects of different matching proposals by sliding to the left or right. As shown as FIG. 3-2, if the first user locks up a skirt displayed on the body of the model, matching effects of other business objects that can match with this shirt may be viewed by sliding to the left or right. For example, when sliding to the right, an interface is displayed as shown in FIG. 3-3. As can be seen, the locked portion corresponding to the shirt does not change, and only a matching jacket is changed.

When an image showing a matching effect is displayed, link information of details page of various business objects may also be provided, as shown in thumbnail images at the middle-bottom portions of FIGS. 3-1-3-3. As such, this facilitates the user to enter into a specific details page to perform operations such as making a purchase.

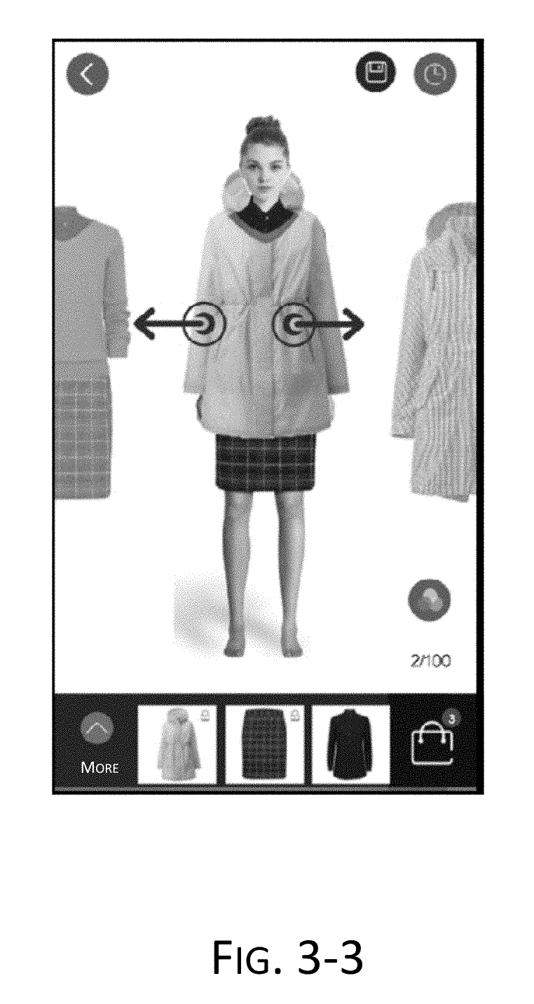

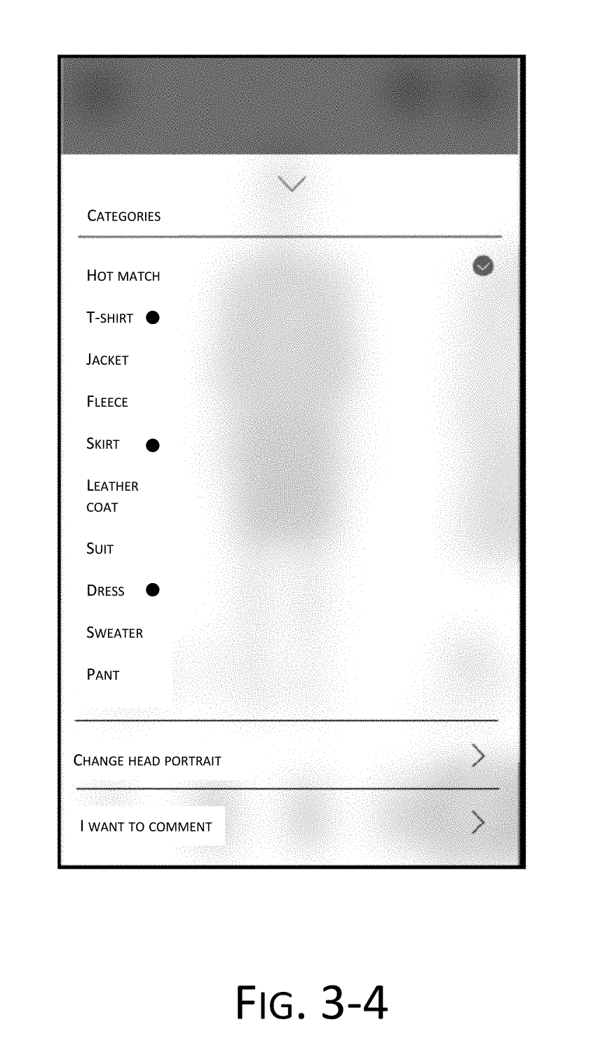

Furthermore, as described in the foregoing text, when various types of matching proposals are returned, the server may also return category information of the second business objects. In this way, when the matching proposals are provided, the client may provide the matching proposals according to respective categories, and the first user can view the matching proposals according to the categories. An example is shown in FIG. 3-4.

In a real application, when viewing various types of matching proposals, the first user may not make a purchase immediately, but needs to temporarily save them. Therefore, an option of operation for saving matching proposal information may also be provided. In response to receiving a request for saving a specific matching proposal from the first user via this option of operation, information of this matching proposal is added into a collection list. In this way, the user can view matching proposal(s) that has/have been saved thereby in a collection list of “fitting room”, as shown in FIG. 3-5. Furthermore, for matching proposals in the collection list, a deletion or a re-matching of a matching proposal can be performed via a prolonged press on an image thereof, for example, and a click on an image can lead to a purchase page, as shown in FIG. 3-6.

Furthermore, an option of operation for sharing matching proposal information may also be provided. When a request for sharing a specific matching proposal is received from the first user via this option of operation, information of this matching proposal is sent to predetermined target first user(s), e.g., buddy user(s) of the sharing party, or user(s) that is/are randomly selected by the system, etc. Operations of the target first user(s) who receive(s) the shared information with respect to the matching proposal may also be monitored, to help performing statistics on information about the use efficiency of the matching proposal information.

### Third Embodiment

The third embodiment is in correspondence with the second embodiment, and is described from the perspective of a client of a first user. Referring to FIG. 4, the third embodiment provides a third example method 400 for providing matching information of a business object. The method 400 may include the following operations.

At S402, a client of a first user receives a request for obtaining matching information of a first business object.

As described in the second embodiment, in implementations, a plurality of different entries exist to receive the request. For example, a detailed information page of a specific first business object, a page of collection list that includes the specific first business object, or a page of order list of transaction that includes the specific first business object receives a request for obtaining matching information of the specific first business object. Alternatively, a request for obtaining matching information can be obtained through a home page of a store or a home page of a fashion channel. In this case, a request for obtaining at least one recommended matching proposal may be submitted to a server. When a single item in a certain matching proposal is locked up, the single item is determined as the specific first business object, and a request for obtaining matching information of the specific first business object is triggered and sent to the server.

At S404, the request is transmitted to a server, to enable the server to return matching proposal information of the specific first business object based on a pre-established matching information database, wherein the matching information database stores at least one matching proposal of the first business object, and the matching proposal includes second business object(s) that match(es) the first business object and matching degree information.

A number of the second business object(s) is at least one, and the first business object and the second business object(s) may be business objects of a fashion category.

At S406, the matching proposal information of the specific first business object is provided based on response information returned from the server.

The response information returned from the server further includes stereo images of the first business object and second business object(s) in the matching proposal. In this case, images showing matching effects may be synthesized using the stereo images and a preconfigured human model. When a number of matching proposals are returned by the server, stereo image(s) of the second business object(s) in the matching proposal can be switched based on a request for switching operation. Furthermore, the matching proposals can also be provided according to categories based on categories to which respective second business objects in various matching proposals belong.

Since the third embodiment is in correspondence with the second embodiment, detailed implementations of operations of the third embodiments can be referenced to the description of the second embodiment, and are not repeatedly described herein.

### Fourth Embodiment

From the first embodiment to the third embodiment as described above, a server establishes a matching information database in advance. In another implementation, a server may calculate respective degrees of matching between a first business object and other business objects in response to receiving a matching request, and return a matching proposal that is determined. This method is more suitable for performing matching and recommendation inside a store, because the number of business objects in the store is relatively few, without causing problems such as a response delay due to a long time needed for calculation after receiving a request.

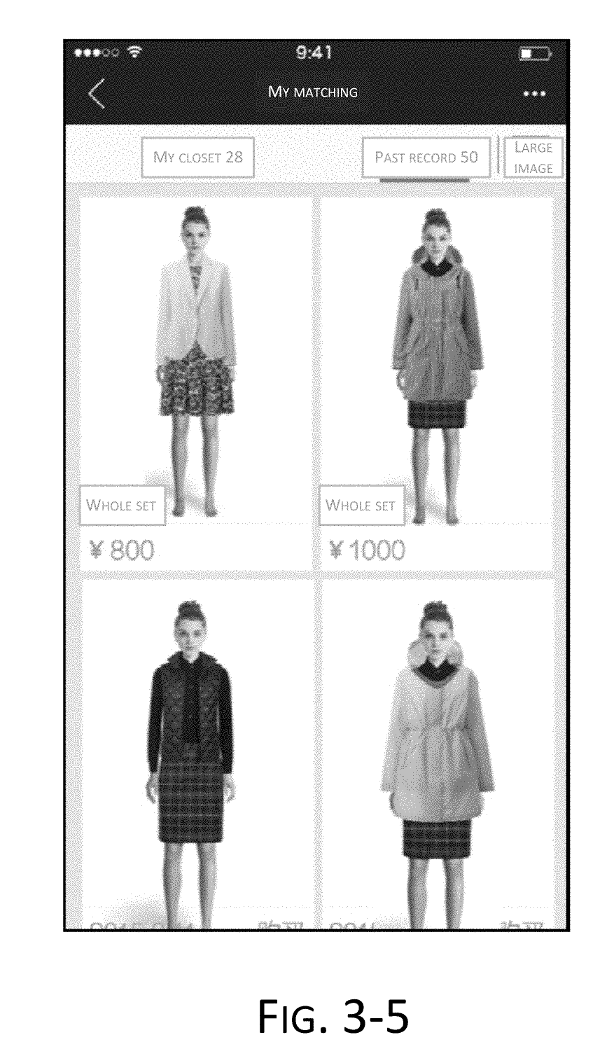

Referring to FIG. 5, the fourth embodiment provides a fourth method 500 for providing matching information of a business object. The method 500 may include the following operations.

At S502, a server receives a request for obtaining matching information of a specific first business object from a client of a first user.

At S504, at least one business object that is selectable is determined when matching with the first business object.

For example, the at least one second business object that is selectable can be determined from a store to which the first business object belongs based on category matching.

At S506, at least one information dimension that is referable is determined when matching with the first business object.

In this embodiment, since degrees of matching between business objects are calculated only after the request of the first user is received, this operation can directly take personalized information of the first user into consideration when determining referable information dimension(s). In other words, the at least one referable information dimension may include specification parameters of the first business object, historical matching information, or personalized information of the first user.

At S508, matching degree information of the second business object and the first business object is determined based on respective property information of the second business object and the first business object with respect to a corresponding dimension.

At S510, matching proposal information of the specific first business object is provided based on the matching proposal information.

Detailed implementations of the operations S504-S508 are similar to the methods when a database is established in the first embodiment, which can be referenced for implementations. Details thereof are not repeatedly described herein.

### Fifth Embodiment

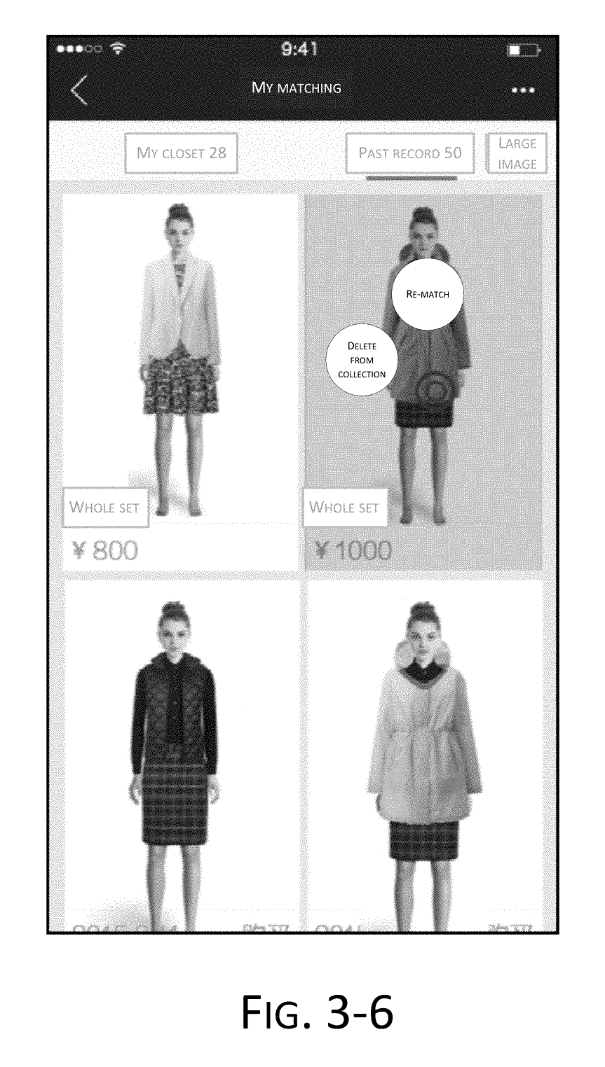

The fifth embodiment is in correspondence with the fourth embodiment, and is described from the perspective of a client. Referring to FIG. 6, the fifth embodiment provides a fifth example method 600 for providing matching information of a business object. The method 600 may include the following operations.

At S602, a client of a first user receives a request for obtaining matching information of a specific first business object.

At S604, the request is transmitted to a server, to enable the server to determine at least one second business object that is selectable when the first business object is matched, determine at least one information dimension that is referable when the first business object is matched, determiner matching degree information between the second business object and the first business object based on respective property information of the second business object and the first business object on a corresponding dimension, and provide matching proposal information of the specific first business object based on the matching degree information.

At S606, the matching proposal information of the specific first business object is provided based on response information returned from the server.

Detailed implementations of the fifth embodiment can similarly be referenced to the description of the foregoing embodiments, and are not repeatedly described herein.

### Sixth Embodiment

As described in the foregoing text, after providing recommendation information of matching proposal(s) to a first user, the first user may save a matching proposal that is of interest. In other words, the first user may save business object information in a collection using a matching proposal as a unit, rather than using a business object as a unit for saving, thus satisfying the need of the user having a matching requirement in a better manner. The embodiments of the present disclosure describe details of an implementation of provision of such collection.

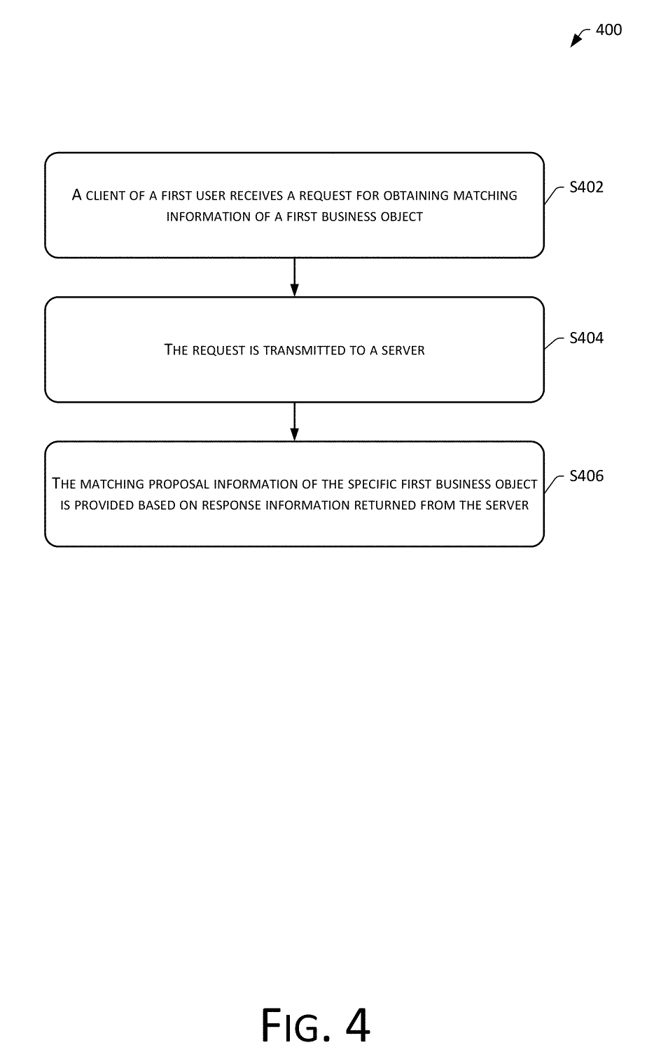

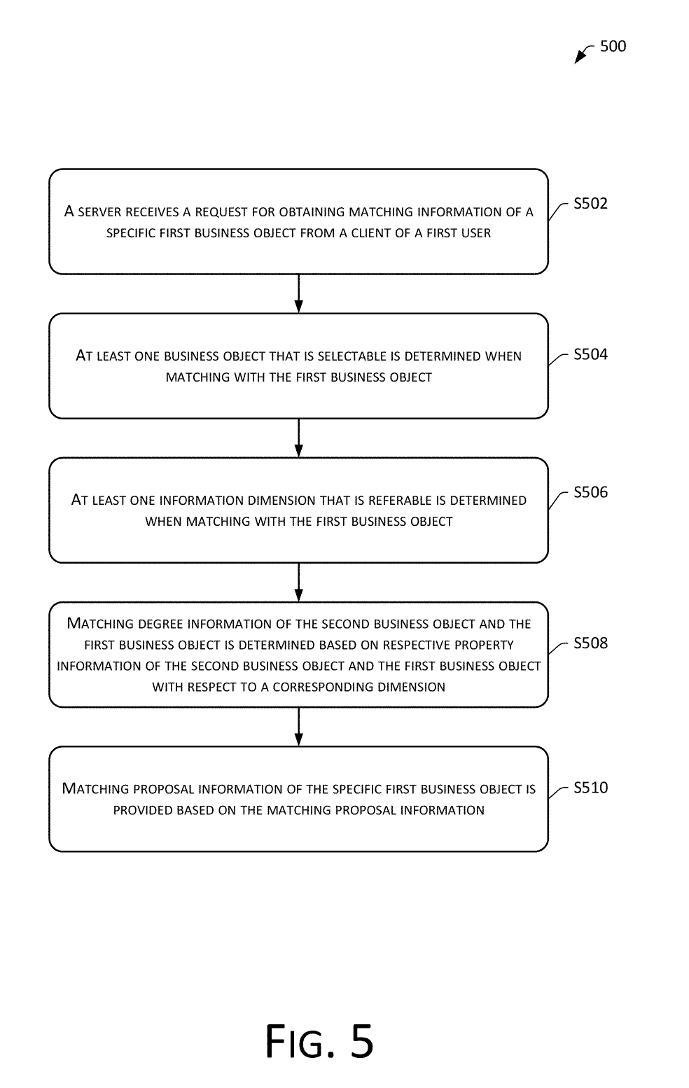

Referring to FIG. 7, the sixth embodiment provides a seventh example method 700 for saving business object information from the perspective of a client of a first user. The method 700 may include the following operations.

At S702, a client of a first user receives a request for obtaining a matching proposal, and determines matching condition(s) that is/are needed.

As described in the foregoing text, the client of the first user may provide a plurality of different entries for entering into a “fitting room” function to the first user. For the client, matching conditions that are determined for these different entries may be different after receiving a matching request from the first user.

With respect to a request for obtaining a matching proposal that is received through a store home page of a target store, a matching condition may be determined as obtaining a matching proposal inside the target store. In this way, a server can determine information of respective stores to which business objects in each matching proposal belong. When information of respective store to which each business object in a certain matching proposal is the target store, a determination is made that this matching proposal fulfills the condition.

If a request for obtaining a matching proposal is received through a home page of a target category channel, property tags of a matching proposal needed by the first user may be determined first, and specifically may be determined based on user characteristics and/or preference information about matching of the first user that are known in advance. Alternatively, the needed property tags of the matching proposal may be determined based on property tags specified by the first user that are submitted by the client of the first user, for example. The matching condition may then be determined as obtaining a matching proposal that satisfies the property tags needed by the first user. In this way, the server can make determination about property tags of various matching proposals, and determine that a certain matching proposal including these property tags is a matching proposal satisfying the condition.

Furthermore, with respect to a request for obtaining a matching proposal that is received through a details page of a specific first business object, a matching condition may be determined as obtaining a matching proposal corresponding to the specific first business object and having second business object(s) therein belonging to a same store to which the specific first business object belongs. This allows a server to retrieve a matching proposal with second business objects and first business object belonging to a same store as a matching proposal fulfilling the condition, from among matching proposals including the specific first business object.

If the request for obtaining a matching proposal is received through a page of collection list that includes a specific first business object or a page of order list of transaction that includes the specific first business object, the matching condition may be determined as obtaining a matching proposal corresponding to the specific first business object. In this way, a server may determine a matching proposal including the specific first business object as a matching proposal fulfilling the condition.

At S704, the request is transmitted to a server, and the request includes information of the matching condition(s), to enable the server to return matching proposal(s) satisfying the matching condition(s) based on a pre-established matching information database, wherein the matching information database stores at least one matching proposal, and each matching proposal includes a respective first business object and second business object(s) matching therewith.

After receiving the request sent from the client of the first user, various matching proposals that satisfy the matching condition(s) can be selected from a matching information database, and returned to the client of the first user. For example, a matching condition is to select a matching proposal for a specific first business object A, and second business objects that can match with the first business object are found to be 1, 2, 3, etc., by querying the matching information database. Therefore, information of these second business objects is returned to the client of the first user.

Apparently, preference information (style preference, brand preference, etc.) of different first users may be different when business objects are selected. For example, some first users like a simple style, some like a vintage style, some like certain specific brands, etc. Moreover, different first users have different purchasing powers, i.e., generally selecting prices in a certain range when making a purchase. Furthermore, information such as group(s) to which the first user belongs may also affect the first user to make a selection of business objects. Therefore, when matching proposals are provided to the first user, these pieces of personalized information of the first user may also be considered. For example, degrees of matching may similarly be calculated between the personalized information and the matching proposals with respect to various dimensions, and further selection or reordering may be performed on the matching proposals, for example.

At S706, information of the matching proposal(s) returned by the server is provided, and an option of operation used for saving the matching proposal(s) is provided.

The information of the matching proposal(s) can be provided to the first user after receiving from the server, and an option of operation used for saving the matching proposal(s) is provided.

In implementations, in the process of providing various types of matching proposals to the client of the first user, the server may also provide images showing matching effects of the various matching proposals to the client of the first user. An image showing a matching effect may include a human model, and the first business object and respective second business object(s) are worn on the human model, to show a wearing effect of the user. Details of implementation can be similar to what is described in the second and third embodiments, and are not repeatedly described herein.

At S708, when a request for saving a specific matching proposal is received through the option of operation, the specific matching proposal and information of related first business object and second business objects are added into collection data of the first user.

When viewing various types of matching proposals, the first user may not make a purchase immediately, but needs to temporarily save them. Therefore, an option of operation for saving matching proposal information may also be provided. In response to receiving a request for saving a specific matching proposal from the first user via the option of operation, information of this matching proposal is added into a collection list. In this way, the user can view matching proposal(s) that has/have been saved thereby in a collection list of “fitting room”, as shown in FIG. 3-5.

Furthermore, when a request for viewing collection data is received, various matching proposals saved by the first user can also be displayed, and an option of operation for manipulating the various saved matching proposals may also be provided. If images showing matching effects are also provided when the various matching proposals are provided, the images showing the matching effects can also be saved when saving in a collection. As such, when a request for viewing collection data is received, for example, the images showing the matching effects corresponding to the various saved matching proposals may also be provided in the page of collection list. Moreover, a list of options of operation may be displayed via a prolonged press on an image, for example. The list of options of operation may include operations such as a deletion or a re-matching of a matching proposal. A click on an image can also lead to a purchase page, as shown in FIG. 3-6. In other words, the options of operation may include a first option of operation used for making a purchase of saved matching proposals. When a request for purchasing a specific matching proposal is received through the first option of operation, respective purchase page addresses of a first business object and second business object(s) in the specific matching proposal can be separately determined, and page jumps can be performed.

The options of operation may also include a second option of operation used for sharing matching proposals that are saved. When a request for sharing a specific matching proposal is received through the second option of operation, the specific matching proposal is shared with specific target first user(s), such as a buddy user of the sharing party, a user randomly selected by the system, etc. Operations of the target first user(s) who receive(s) the shared information with respect to the matching proposal may also be monitored, to help performing statistics on information about the use efficiency of the matching proposal information.

The options of operation may also include a third option of operation used for re-matching matching proposals that are saved. When a request for re-matching a specific matching proposal is received through the third option of operation, an option of operation used for locking up single item(s) is provided, to enable a lock-up of a single item and send a request for obtaining a matching proposal corresponding to the single item to the server.

Furthermore, a fourth option of operation used for removing saved matching proposals from a collection may also be included. When a request for removing a specific matching proposal is received through the fourth option of operation, the specific matching proposal is removed from collection data of the first user.

Using the methods provided in the embodiments, matching proposals can be recommended and provided to a first user automatically. Furthermore, the user can save an entire matching proposal in a collection, rather than saving individual single items. As such, a buying user can select a second business object having a relatively good matching effect with a first business object selected thereby, without frequently performing operations such as category switching. For a system, this saves resources caused by user operations such as category switching, and helps reducing the access pressure and workload of a server.

### Seventh Embodiment

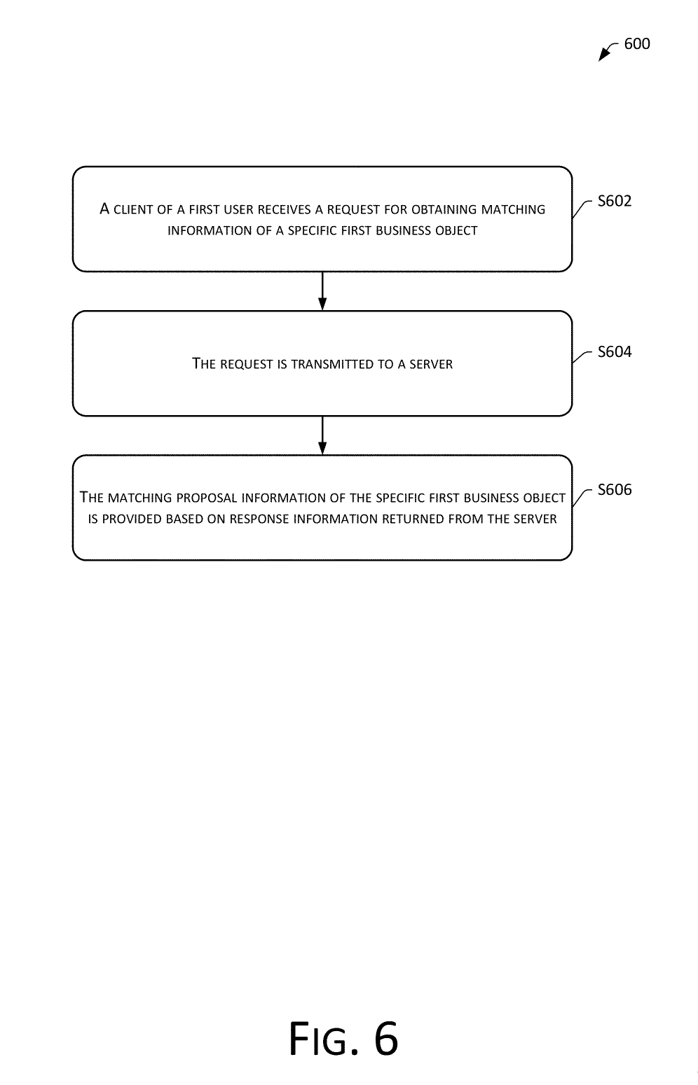

The seventh embodiment is in correspondence with the sixth embodiment, and is described from the perspective of a server. Referring to FIG. 8, the seventh embodiment provides a seventh method 800 for saving business object information. The method 800 may include the following operations.

At S802, a server pre-establishes a matching information database, the matching information database storing at least one matching proposal, and each matching proposal including a first business object and second business object(s) matching therewith.

A method of establishing a matching information database by a server can be referenced to the foregoing description. Apparently, in implementations, other methods can be used for establishing this database, and the present disclosure has no limitation thereon.

At S804, a request for obtaining matching proposal information is received from a client of a first user, the request including matching condition information.

At S806, matching proposal(s) satisfying matching condition(s) is/are returned from the matching information database based on the matching condition(s), to enable the client of the first user to provide the matching proposal(s) satisfying the matching condition(s), provide an option of operation for saving in a collection, and add information of a specific matching proposal and related first business object and related second business object(s) into collection data of the first user in response receiving a request for saving the specific matching proposal through the option of operation.

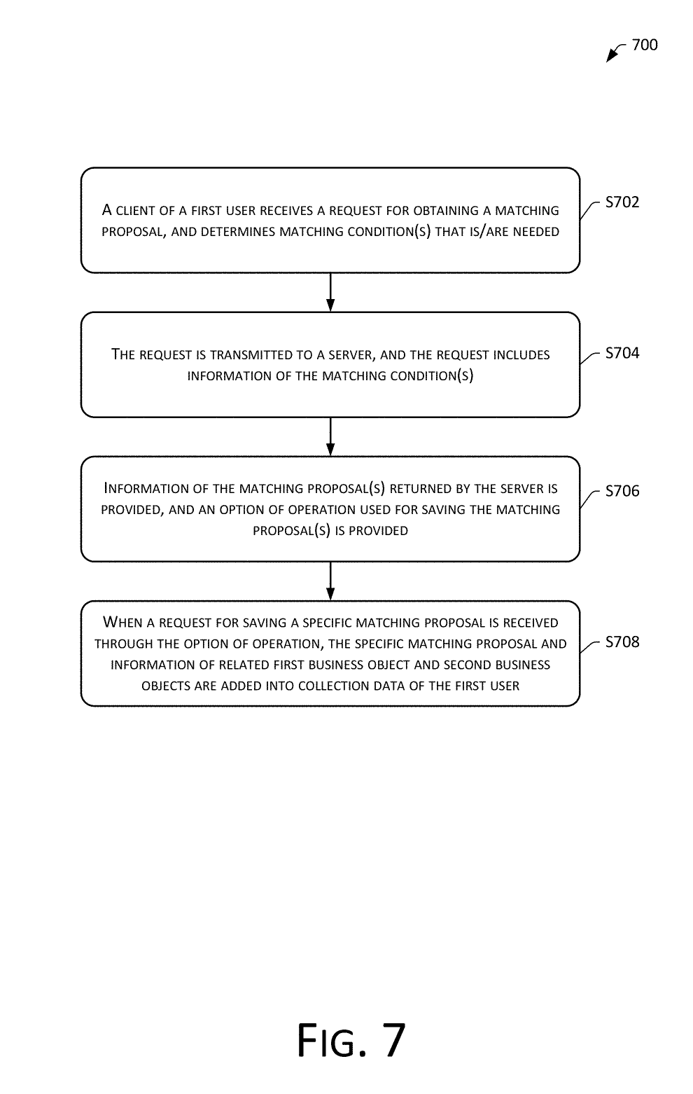

Corresponding to the method for establishing a matching information database of business objects provided in the first embodiment, the embodiments of the present disclosure also provide an apparatus 900 for establishing a matching information database of business objects. Referring to FIG. 9, the apparatus 900 may include one or more processors 902, an input/output (I/O) interface 904, a network interface 906, and memory 908.

The memory 908 may include a form of computer readable media such as a volatile memory, a random access memory (RAM) and/or a non-volatile memory, for example, a read-only memory (ROM) or a flash RAM. The memory 908 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 908 may include program units 910 and program data 912. The program units 910 may include a selectable business object determination unit 914 used for determining at least one second business object that is selectable when matching a first business object; an information dimension determination unit 916 used for determining at least one information dimension that is referable when matching the first business object; a matching degree determination unit 918 used for determining matching degree information between the second business object and the first business object based on respective property information of the second business object and the first business object on a corresponding dimension; and a matching proposal generation unit 920 used for generating at least one matching proposal corresponding the first business subject, and storing thereof in the matching information database, the matching proposal including a second business object that matches the first business object and corresponding matching degree information.

The referable information dimension is a specification parameter of the first business object, and the information dimension determination unit 916 may be used for determining the matching degree information between the second business object and the first business object based on respective property information of the second business object and the first business object on dimensions of specification parameters. In this case, the matching degree determination unit 918 may include a dimension individual determination subunit 922 used for separately determining degrees of matching between the second business object and the first business object on the dimensions based on preset matching rule information for the dimensions of specification parameters; and a combination determination subunit 924 used for combining the degrees of matching with the first business object on the dimensions to determine the matching degree information of the second business object and the first business object.

In another implementation, the referable information dimension is historical matching information, and the historical matching information is obtained using the following method: an activity data acquisition unit used for obtaining data of historical activity records of the first user; an activity data determination unit used for determining whether target first user(s) having performed a preset operation on the first business object performs, within a preset time period associated with performing the preset operation, the preset operation on a certain business object; and a collection unit used for aggregating results of the determining to determine a first matching object set that the first user has selected for the first business object.

The matching degree determination unit 918 is used for determining whether the second business object exists in the first matching object set, and determining the matching degree information of the second business object and the first business object based on a determination result.

The historical matching information may be obtained by: an exemplary matching proposal acquisition unit 926 used for obtaining an exemplary matching proposal and determining identifiers of business objects corresponding to single items in the matching proposal; and a set determination unit 928 used for determining a second matching object set of the first business object in the exemplary matching proposal.

The matching degree determination unit 918 is used for determining whether the second business object appears in the second matching object set, and determining the matching degree information of the second business object and the first business object based on a determination result.

The exemplary matching proposal acquisition unit 926 may include a first acquisition subunit 930 used for obtaining the exemplary matching proposal based on matching information submitted by a second user.

Alternatively, the exemplary matching proposal acquisition unit 926 may also include an image acquisition subunit 932 used for obtaining an exemplary matching image; and an identifying subunit 934 used for identifying identifiers of business objects corresponding to single items that form the matching proposal in the image.

In implementations, the matching degree determination unit 918 includes a score determination subunit 936 used for determining scores of degrees of matching between the second business object and the first business object with respect to various dimensions; and a score combination subunit 938 used for determining a sum of the scores with respect to the various dimensions as the matching degree information of the second business object and the first business object.

Furthermore, the apparatus 900 may further include a property tag storage unit 940 used for storing property tags of the matching proposal in the matching information database, the property tags being used for describing one or more of the following items: a style, a price and a wearing occasion, or a group associated with the matching proposal.

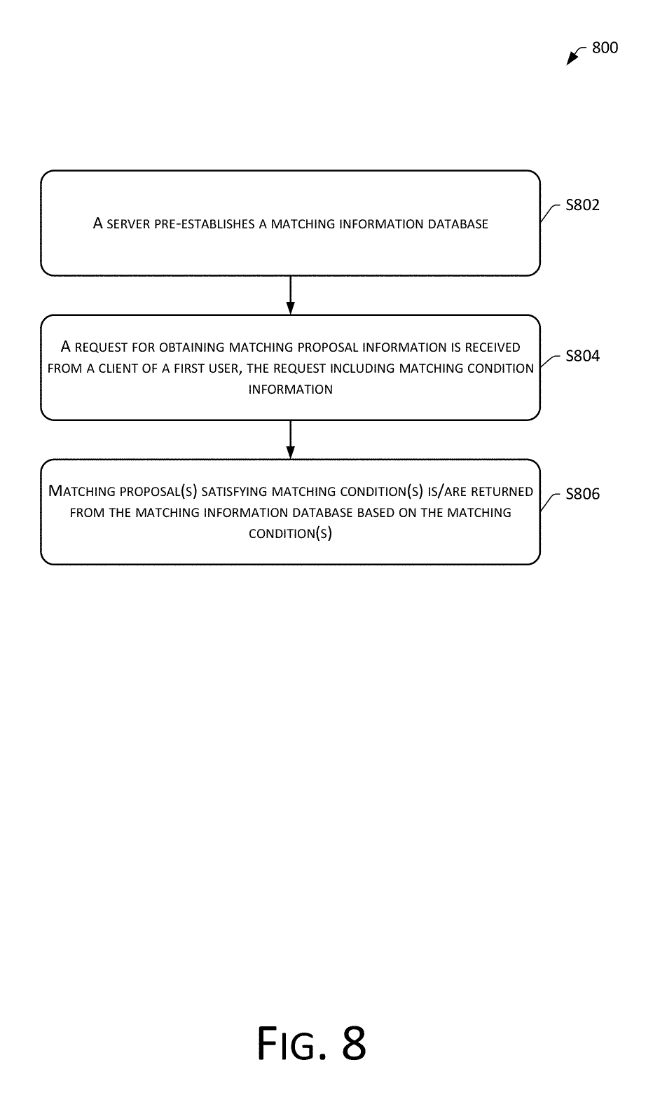

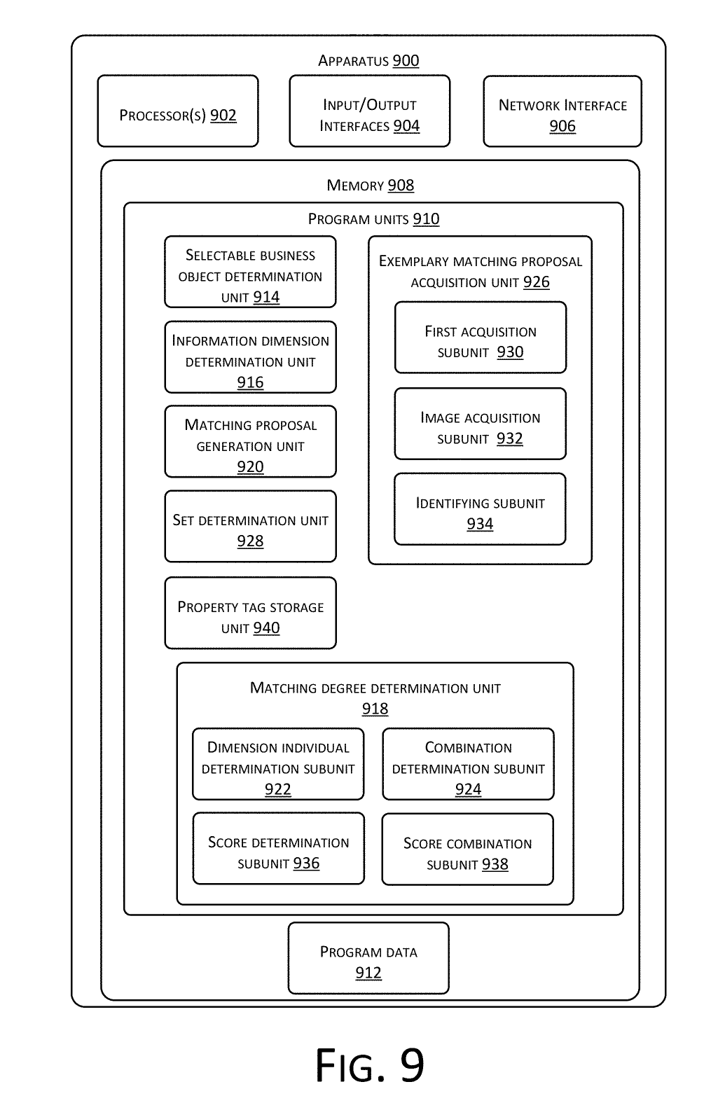

Corresponding to the method for providing matching information of a business object provided in the second embodiment, the embodiments of the present disclosure also provide an apparatus 1000 for providing matching information of a business object. The apparatus 1000 is applied in a server. Referring to FIG. 10, the apparatus 1000 may include one or more processors 1002, an input/output (I/O) interface 1004, a network interface 1006, and memory 1008. The memory 1008 may include a form of computer readable media as described in the foregoing description.

In implementations, the memory 1008 may include program units 1010 and program data 1012. The program units 1010 may include a database creation unit 1014 used for pre-establishing a matching information database for business object of a fashion category, the matching information database storing at least one matching proposal corresponding to a first business object, and the matching proposal including second business object that can match with the first business object and matching degree information; a request receiving unit 1016 used for receiving a request for obtaining matching information of a specific first business object sent from a client of a first user; and a matching proposal provision unit 1018 used for providing matching proposal information of the specific first business object according to the matching information database.

The request includes information of an access source.

The matching proposal provision unit 1018 includes a matching mode determination subunit 1020 used for selecting a matching mode for the access source; and a matching proposal determination subunit 1022 used for providing the matching proposal information of the specific first business object according to the matching mode and the matching information database.

The access source includes a details page of the specific first business object or a home page of a store. The matching information database also stores identifier information of stores to which the first business object and the second business object respectively belong.

The matching mode determination subunit 1020 is used for selecting a first matching mode based on the access source, the first matching mode as selecting a matching proposal from a store to which the first business object belongs.

The matching proposal determination subunit 1022 includes a target set determination subunit 1024 used for determining a target matching proposal set corresponding to the specific first business object from the matching information database; and a selection subunit 1026 used for selecting a target matching proposal having a same store from the target matching proposal set based on the first matching mode, and providing the target matching proposal to the client of the first user.

The access source includes a home page of a channel, a page of a collection list including the specific first business object, or a page of an order list of transactions including the specific first business object.

The matching proposal determination subunit 1022 is used for selecting a second matching mode based on the access source, the second matching mode as providing a matching proposal across stores.

The matching proposal determination subunit 1022 is used for determining a target matching proposal set corresponding to the specific first business object from the matching information database based on the second matching mode, and providing the target matching proposal set to the client of the first user.

When the access resource is a home page of a store, the apparatus further includes a first recommended matching proposal provision unit 1028 used for providing recommended matching proposals of the store to the client of the first user according to the matching information database before receiving the request for obtaining the matching information of the specific first business object sent from the client of the first user, to enable the client of the first user to provide the recommended matching proposals to the first user, and determine a single item as the specific first business object when the first user locks the single item in a certain matching proposal, and send the request for obtaining the matching information of the specific first business object to the server.

The matching information database further stores property tags of the matching proposal, the property tags being used for describing one or more items of the following items: a style, a price, a suitable wearing occasion, or a group associated with the matching proposal.

When the access source is a home page of a fashion channel, the apparatus 1000 further includes a property tag determination unit 1030 used for determining property tags of a matching proposal needed by the first user before the request for obtaining the matching information of the specific first business object is received from the client of the first user; and a second recommended matching proposal provision unit 1032 used for providing matching proposal(s) matching the property tags to the client of the first user, to enable the client of the first user to provide the matching proposal(s) to the first user, determine a single item as the specific first business object when the first user locks the single item in a certain matching proposal, and send the request for obtaining the matching information of the specific first business object to the server.

The property tag determination unit 1030 may include a first tag determination subunit 1034 used for determining the property tags of the matching proposal needed based on user characteristics of the first user and/or preference information of fashion matching that are known in advance.

Alternatively, the property tag determination unit 1030 includes a second tag determination subunit 1036 used for determining the property tags of the matching proposal needed based on property tags that are specified by the first user and submitted by the client of the first user.

In implementations, the matching proposal provision unit 1018 may further include a personalized information determination subunit 1038 used for determining personalized information of the first user when a business object is selected; and a proposal provision subunit 1040 used for providing the matching proposal corresponding to the specific first business object according to the personalized information and the matching information database.

The apparatus 1000 may further includes an image information provision unit 1042 used for providing information of images showing matching effects of various matching proposals when the matching proposal information of the specific first business object is provided.

The image information provision unit 1042 includes an identifier sending subunit 1044 used for sending information of identifiers of the first business object and second business objects included in the matching proposals to an image synthesis server, to cause the image synthesis server to determine respective stereo images of the first business object and the second business objects using a pre-stored image database, and use the respective stereo images and a preconfigured human model to form the images showing the matching effects for returning; and a matching effect display image provision subunit 1046 used for providing the images showing the matching effects that are returned by the image synthesis server to the client of the first user.

Alternatively, the image information provision unit 1042 includes a stereo image determination subunit 1048 used for determining stereo images of the first business object and second business objects included in the various matching proposals; and a stereo image provision subunit 1050 used for providing the stereo images to the client of the first user, to enable the client of the first user to use the stereo images and a preconfigured human model to form the images showing the matching effects.

The apparatus 1000 may further include a details page link information provision unit 1052 used for providing link information of a details page of a second business object included in the matching proposal when the matching proposal of the specific first business object is provided. The apparatus 1000 may further include a collection operation option provision unit 1054 used for providing an option of operation for saving the matching proposal information in a collection; and a collection unit 1056 used for adding information of a specific matching proposal into a collection list in response to receiving a request for saving the specific matching proposal from the first user through the option of operation. The apparatus 1000 may further include a sharing operation option provision unit 1058 used for providing an option of operation for sharing the matching proposal; and a sharing unit 1060 used for sending information of a specific matching proposal to preset target first user(s) in response to receiving a request for sharing the specific matching proposal from the first user through the option of operation.

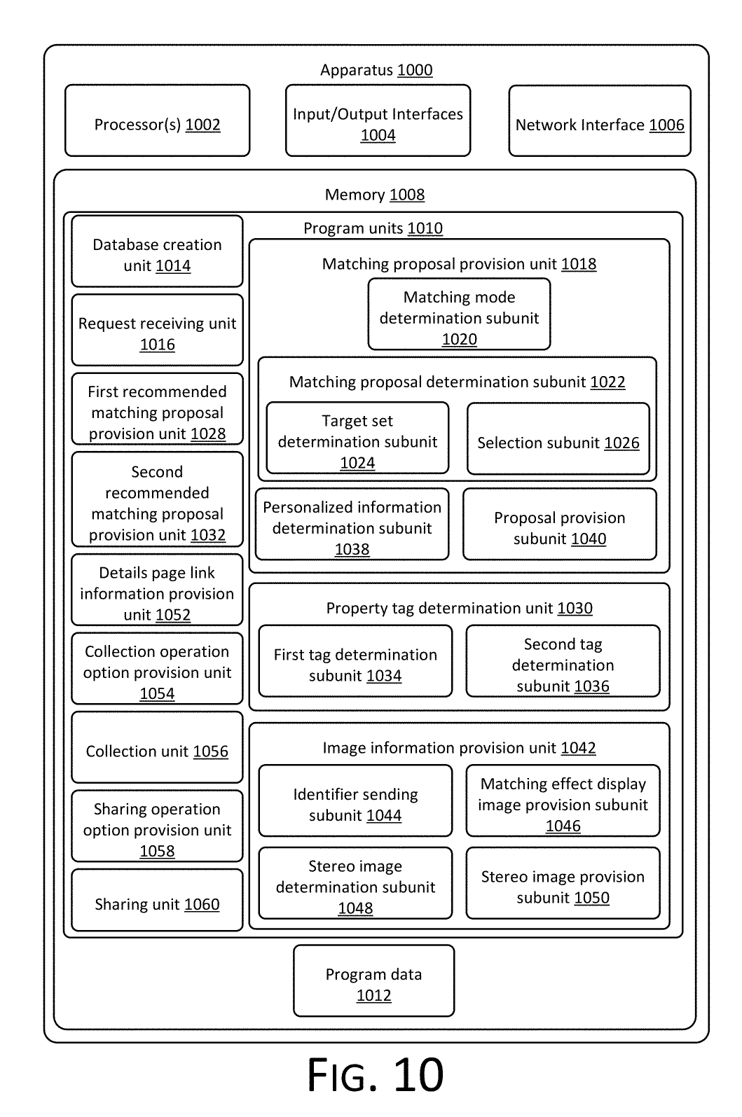

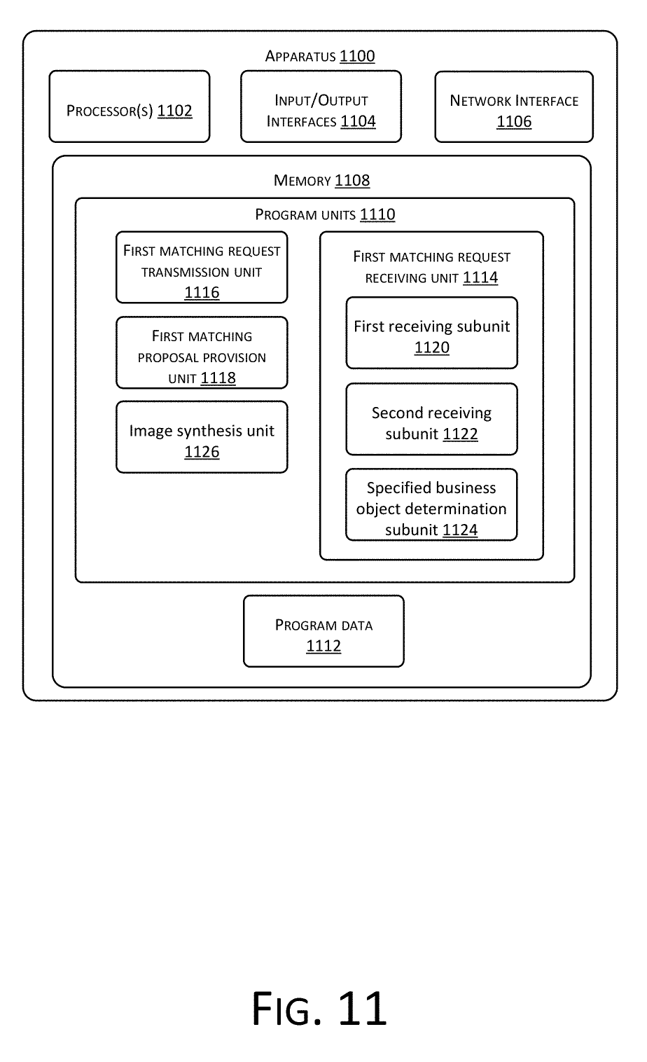

Corresponding to the method for providing matching information of a business object provided in the third embodiment, the embodiments of the present disclosure further provide an apparatus 1100 for providing matching information of a business object. The apparatus 1100 is applied in a client of a first user. Referring to FIG. 11, the apparatus 1100 may include one or more processors 1102, an input/output (I/O) interface 1104, a network interface 1106, and memory 1108. The memory 1108 may include a form of computer readable media as described in the foregoing description.

In implementations, the memory 1108 may include program units 1110 and program data 1112. The program units 1110 may include a first matching request receiving unit 1114 used for receiving a request for obtaining matching information of a specific first business object; a first matching request transmission unit 1116 used for transmitting the request to a server, to enable the server to return matching proposal information of the specific first business object according to a pre-established matching information database, the matching information database storing respective one or more matching proposals of first business object(s), and the respective matching proposals storing respective second business objects that can match with the first business object(s), and respective matching degree information; and a first matching proposal provision unit 1118 used for providing the matching proposal information of the specific first business object based on response information returned by the server.

In implementations, the first matching request receiving unit 1114 includes a first receiving subunit 1120 used for receiving the request for obtaining the matching information of the specific first business object through a details page of the specific first business object, a page of a collection list including the specific first business object, or a page of an order list of transactions including the specific first business object.

Alternatively, the first matching request receiving unit 1114 includes a second receiving subunit 1122 used for receiving the request for obtaining the matching information through a home page of a store or a home page of a fashion channel; a recommendation matching request subunit used for sending a request for obtaining at least one recommended matching proposal to the server; and a specified business object determination subunit 1124 used for determining a single item as the specific first business object when the single item in a certain recommended matching proposal is locked, and triggering to send the request for obtaining the matching information of the specific first business object to the server.

The response information returned by the server also includes respective stereo images corresponding to the first business object and second business object(s) in the matching proposal. The apparatus 1100 further includes an image synthesis unit 1126 used for using the stereo images and a preconfigured human model to form images showing matching effects.

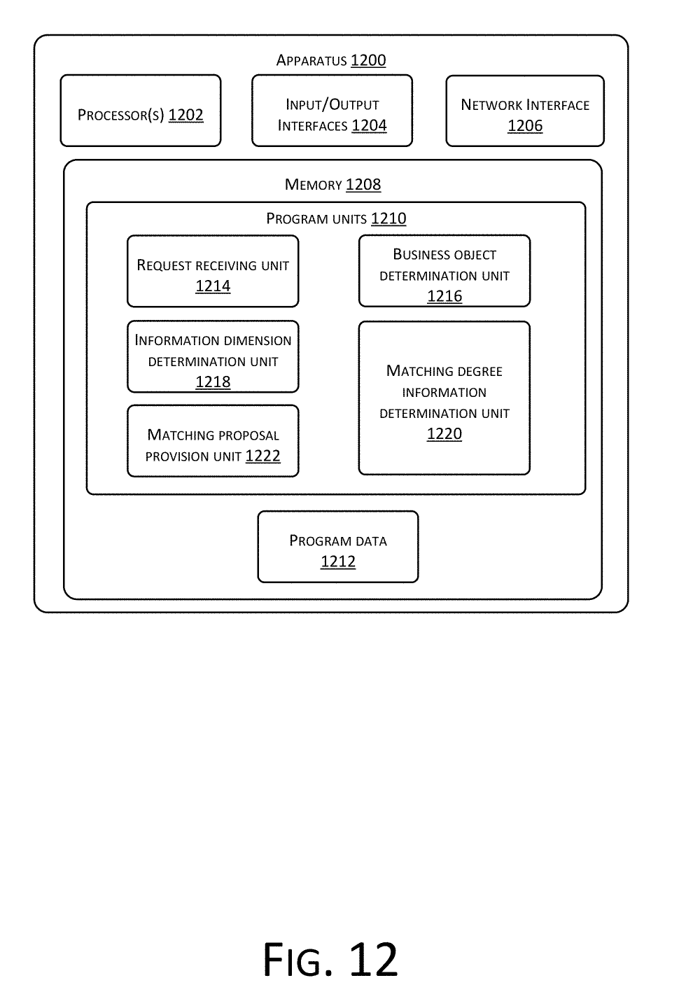

Corresponding to the method for providing matching information of a business object provided in the fourth embodiment, the embodiments of the present disclosure further provide an apparatus 1200 for providing matching information of a business object. The apparatus 1200 is applied in a server. Referring to FIG. 12, the apparatus 1200 may include one or more processors 1202, an input/output (I/O) interface 1204, a network interface 1206, and memory 1208. The memory 1208 may include a form of computer readable media as described in the foregoing description.

In implementations, the memory 1208 may include program units 1210 and program data 1212. The program units 1210 may include a request receiving unit 1214 used for receiving a request for obtaining matching information of a specific first business object sent from a client of a first user; a business object determination unit 1216 used for determining at least one business object that is selectable when the first business object is matched; an information dimension determination unit 1218 used for determining at least one information dimension that is referable when the first business object is matched; a matching degree information determination unit 1220 used for determining matching degree information of the second business object and the first business object based on property information of the second business object and the first business object with respect to a corresponding dimension; and a matching proposal provision unit 1222 used for providing matching proposal information of the specific first business object based on the matching degree information.

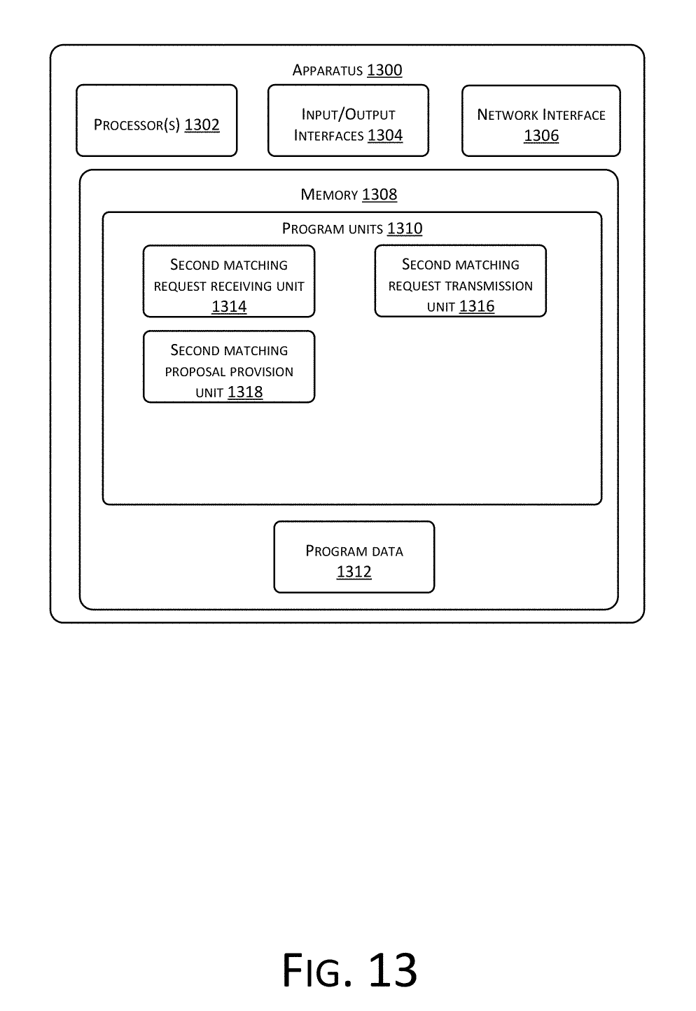

Corresponding to the method for providing matching information of a business object provided in the fifth embodiment, the embodiments of the present disclosure also provides an apparatus 1300 for providing matching information of a business object. The apparatus 1300 is applied in a client of a first user. Referring to FIG. 13, the apparatus 1300 may include one or more processors 1302, an input/output (I/O) interface 1304, a network interface 1306, and memory 1308. The memory 1308 may include a form of computer readable media as described in the foregoing description.

In implementations, the memory 1308 may include program units 1310 and program data 1312. The program units 1310 may include may include a second matching request receiving unit 1314 used for receiving a request for obtaining matching information of a specific first business object; a second matching request transmission unit 1316 used for transmitting the request to a server, to cause the server to determine at least one second business object that is selectable when matching the first business object, determine at least one information dimension that is referable when matching the first business object, determine matching degree information between the second business subject and the first business object based on property information of the second business object and the first business object with respect to a corresponding dimension, and provide matching proposal information of the specific first business object based on the matching degree information; and a second matching proposal provision unit 1318 used for providing the matching proposal information of the specific first business object based on response information returned by the server.

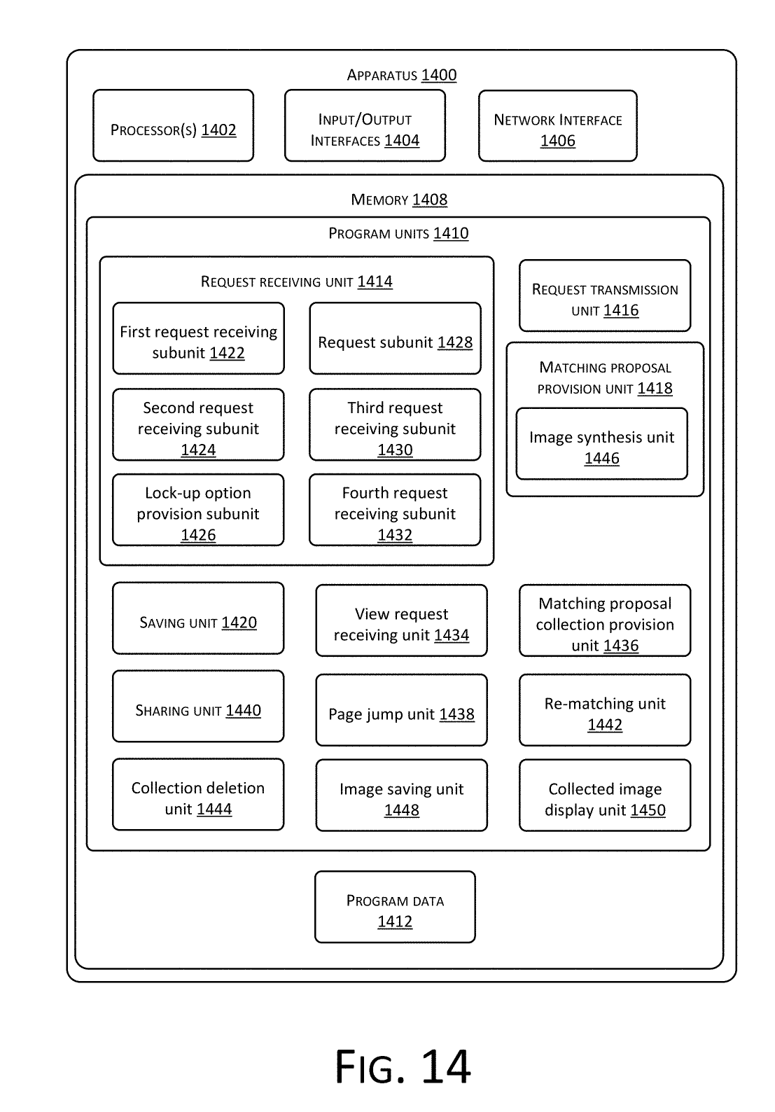

Corresponding to the method of saving business object information provided in the sixth embodiment, the embodiments of the present disclosure further provides an apparatus 1400 of saving business object information, which is applied in a client of a first user. Referring to FIG. 14, the apparatus 1400 may include one or more processors 1402, an input/output (I/O) interface 1404, a network interface 1406, and memory 1408. The memory 1408 may include a form of computer readable media as described in the foregoing description.

In implementations, the memory 1408 may include program units 1410 and program data 1412. The program units 1410 may include a request receiving unit 1414 used for receiving a request for obtaining a matching proposal, and determining required matching condition(s); a request transmission unit 1416 used for transmitting the request to a server, and including information of the matching condition(s) in the request, to enable the server to return matching proposal(s) fulfilling the matching condition(s) according to a pre-established matching information database, wherein the matching information database sores at least one matching proposal, and each matching proposal includes a respective first business object and respective second business object(s) matching therewith; a matching proposal provision unit 1418 used for providing information of the matching proposal(s) returned by the server, and providing an option of operation for saving the matching proposal(s); and a saving unit 1420 used for adding information of a specific matching proposal, and related first business object and second business object(s) into collection data of the first user in response to receiving a request for saving the specific matching proposal through the option of operation.

The request receiving unit 1414 includes a first request receiving subunit 1422 used for receiving the request for obtaining the matching proposal through a home page of a target store, and the matching condition(s) is/are determined as obtaining matching proposal(s) within the target store, to enable the server to determine information of stores to which various business objects in various matching proposals belongs, and determine a certain matching proposal as a matching proposal fulfilling the condition(s) if stores to which respective business objects therein belong are the target store.

Alternatively, the request receiving unit 1414 includes a second request receiving subunit 1424 used for receiving the request for obtaining the matching proposal through a home page of a target category channel, and determining property tags of a matching proposal needed, the property tags being used for describing one or more items of the following items: a style, a price, a suitable wearing occasion or group associated with a corresponding matching proposal, and the matching condition(s) is/are determined as obtaining matching proposal(s) satisfying the property tags, to enable the server to determine respective property tags of various matching proposals, and determine a certain matching proposal as a matching proposal satisfying the condition(s) if the needed property tags included therein.

In implementations, the apparatus 1400 further includes a lock-up option provision subunit 1426 used for providing an option of operation used for locking a specific single item in a recommended matching proposal after matching proposal information that is returned by the server is provided; and a request subunit 1428 used for determining the single item as the specific first business object in response to the single item in the recommended matching proposal is locked up, and sending the request for obtaining the matching proposal of the specific first business object to the sever, to cause the server to return the matching proposal information corresponding to the specific first business object.

In another situation, the request receiving unit 1414 includes a third request receiving subunit 1430 used for receiving the request for obtaining the matching proposal through a details page of the specific first business object, and the matching condition(s) is/are determined as obtaining matching proposal(s) corresponding to the specific first business object and having second business objects therein belonging to a same store of the specific first business object, to enable the server to retrieve a matching proposal in which second business objects and the first business object belong to the same store as a matching proposal satisfying the condition(s), from among matching proposals that include the specific first business object.

Furthermore, the request receiving unit 1414 may further include a fourth request receiving subunit 1432 used for receiving the request for obtaining the matching proposal through a display page of a collection list including the specific first business object or a page of an order list of transactions including the specific first business object, and the matching condition(s) is/are determined as obtaining a matching proposal corresponding to the specific first business object, to enable the server to determine matching proposals including the specific first business object as matching proposals fulfilling the condition(s).

In implementations, the apparatus 1400 may further include a view request receiving unit 1434 used for receiving a request for viewing collection data; a matching proposal collection provision unit 1436 used for providing a plurality of matching proposals saved by the first user, and providing option(s) of operation used for manipulating the plurality of saved matching proposals.

The option(s) of operation used for manipulating the plurality of saved matching proposals includes a first option of operation used for purchasing the plurality of saved matching proposals, and the apparatus 1400 further includes a page jump unit 1438 used for individually determining purchase page addresses corresponding to a respective first business object and respective second business object(s) in a specific matching proposal and performing page jumps in response to receiving a request for purchasing the specific matching proposal through the first option of operation.

The option(s) of operation used for manipulating the plurality of saved matching proposals includes a second option of operation used for sharing the plurality of saved matching proposals, and the apparatus 1400 further includes a sharing unit 1440 used for sharing a specific matching proposal to target first user(s) that is/are specified in response to receiving a request for sharing the specific matching proposal through the second option of operation.

The option(s) of operation used for manipulating the plurality of saved matching proposals includes a third option of operation used for re-matching the plurality of saved matching proposals, and the apparatus 1400 further includes a re-matching unit 1442 used for providing an option of operation used for locking up a single item in response to receiving a request for re-matching a specific matching proposal, and sending a request for obtaining a matching proposal matching the single item that is locked up to the server for the single item.

The option(s) of operation used for manipulating the plurality of saved matching proposals includes a fourth option of operation used for deleting the plurality of saved matching proposals, and the apparatus 1400 further includes a collection deletion unit 1444 used for deleting a specific matching proposal from the collection data of the first user in response to receiving a request for deleting the specific matching proposal through the fourth option of operation.

The matching proposal information returned by the server further includes respective stereo images of the first business object and second business objects in a matching proposal.

The matching proposal provision unit 1414 includes an image synthesis unit 1446 used for using the respective stereo images and a preconfigured human model to form an image showing a matching effect, and providing the image showing the matching effect.

The apparatus 1400 may further include an image saving unit 1448 used for adding an image showing a matching effect corresponding to a specific matching proposal into the collection data of the first user in response to receiving a request for saving the specific matching proposal through the option of operation; and a collected image display unit 1450 used for providing respective images displaying matching effects corresponding to the plurality of saved matching proposals in the display page of the collection list.

The first business object and the second business objects include business objects of a fashion category.

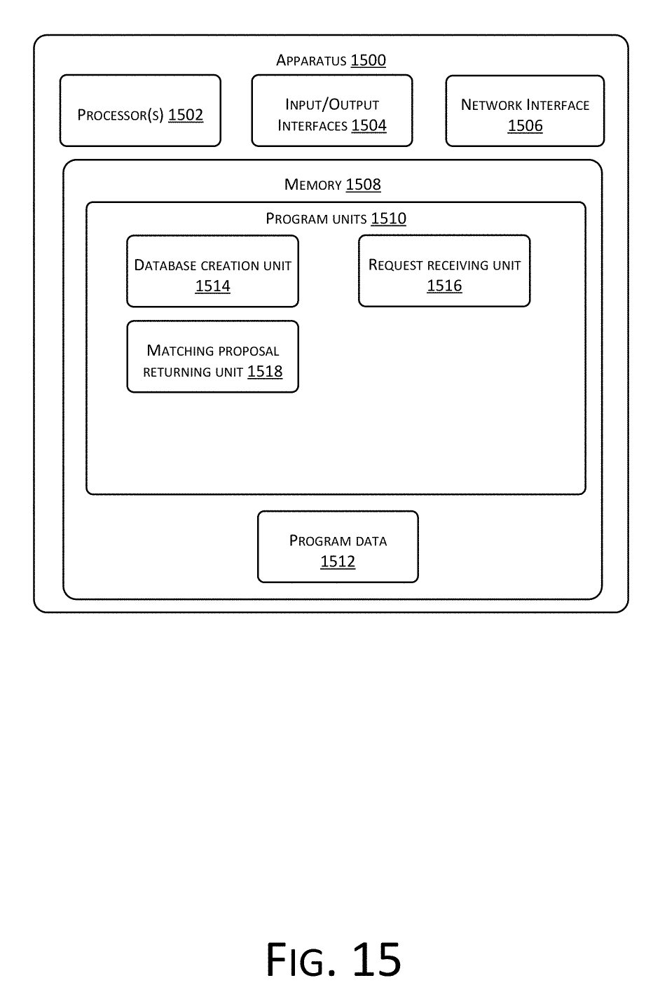

Corresponding to the method of saving business object information provided in the seventh embodiment, the embodiments further provide an apparatus 1500 of saving business object information, which is applied in a server. Referring to FIG. 15, the apparatus 1500 may include one or more processors 1502, an input/output (I/O) interface 1504, a network interface 1506, and memory 1508. The memory 1508 may include a form of computer readable media as described in the foregoing description.

In implementations, the memory 1508 may include program units 1510 and program data 1512. The program units 1510 may include may include a database creation unit 1514 used for pre-establishing a matching information database, the matching information database storing at least one matching proposal, and each matching proposal including a respective first business object and respective second business object(s) matching therewith; a request receiving unit 1516 used for receiving a request for obtaining matching proposal information sent by a client of a first user, the request including information of matching condition(s); a matching proposal returning unit 1518 used for returning matching proposal(s) satisfying the matching condition(s) from the matching information database based on the matching condition(s), to enable the client of the first user to provide the matching proposal(s) satisfying the matching condition(s) and provide an option of operation for saving, and adding information of a specific matching proposal and related first business object and second business object(s) into collection data of the first user in response to receiving a request for saving the specific matching proposal through the option of operation.

As can be seen from the description of the above embodiments, one skill in the art can clearly understand that the present disclosure can be implemented in a form of a software component with a necessary hardware platform. Based on this understanding, the essence of the technical solutions of the present disclosure or the portions that provide contributions to the existing technologies can be implemented in a form of a software product. This computer software product may be stored in storage media, such as ROM/RAM, a magnetic disk, an optical disk, etc., and includes instructions used for causing a computing device (which can be a personal computer, a mobile device, a server, or a networked device, etc.) to perform the method described in the embodiments or portions of the embodiments of the present disclosure.

The embodiments of the present disclosure are described in a progressive manner. The same or similar portions of the embodiments can be referenced with each other. Each embodiment places an emphasis differently from other embodiments. Because of being basically similar to the method embodiments, the systems or system embodiments are described relatively briefly, and can be referenced to related portions of the method embodiments. The foregoing systems and system embodiments are merely exemplary. Units that are described as separate components may or may not be physically separate. A component that is presented as a unit may or may not be a physical unit, i.e., may be located in a single location, or may be distributed among a plurality of network units. Some or all of the modules may be selected to implement the purpose of the solution of the present embodiments based on actual needs. One of ordinary skill in the art can understand and implement the present disclosure without making any creative effort.

Methods and apparatuses for providing matching information of a business object that are provided by the present disclosure are described in detail above. The present text uses specific examples to describe the principles and embodiments of the present disclosure. The description of the above embodiments is merely used to help understand the methods and concepts of the present disclosure. Based on the concepts of the present disclosure, one of ordinary skill in the art can make changes to the specific embodiments and application scopes. In short, content of the present specification should not be construed as limitations to the present disclosure.

The present disclosure may be further understood with clauses as follows.

Clause 1: A method for establishing a matching information database of business objects, comprising: determining at least one second business object that is selectable when matching a first business object; determining at least one information dimension that is referable when matching the first business object; determining matching degree information between the second business object and the first business object based on respective property information of the second business object and the first business object with respect to a corresponding dimension; and generating and storing at least one matching proposal corresponding to the first business object in a matching information database, the matching proposal including a second business object that matches the first business object and corresponding matching degree information.

Clause 2: The method of Clause 1, wherein determining the at least one second business object that is selectable when matching the first business object comprises determining the at least one second business object based on preset category matching information and a category to which the first business object belongs.

Clause 3: The method of Clause 2, wherein referable information dimensions for different target categories are different when matching the first business object.

4. The method of Clause 1, wherein the at least one second business object that is selectable when matching the first business object includes other business objects belonging to a same store of the first business object, or business objects of other stores.

Clause 5: The method of Clause 1, wherein the information dimension that is referable includes a specification parameter of the first business object, and determining the matching degree information between the second business object and the first business object based on the respective property information of the second business object and the first business object with respect to the corresponding dimension comprises determining the matching degree information between the second business object and the first business object based on respective specification parameter information of the second business object and the first business object with respect to the corresponding dimension.

Clause 6: The method of Clause 5, wherein the specification parameter information comprises one or more of the following: a color, materials, a design, a style, whether to include a certain fashion element, or a price.

Clause 7: The method of Clause 5, wherein determining the matching degree information between the second business object and the first business object based on the respective specification parameter information of the second business object and the first business object with respect to the corresponding dimension comprises: separately determining degrees of matching between the second business object and the first business object with respect to dimensions of specification parameters based on information of preset matching rules for the dimensions; and combining the degrees of matching with the first business object with respect to the dimensions to determine the matching degree information of the second business object and the first business object.

Clause 8: The method of Clause 7, wherein matching rules comprise a positive rule and a mutual exclusive rule, the positive rule being used for representing a target specification parameter value that is allowed to match with a certain specification parameter value under a specific dimension, and the mutual exclusive rule being used for representing a target specification parameter value that is not allowed to match with the certain specification parameter value under the specific dimension.

Clause 9: The method of Clause 1, wherein the information dimension that is referable includes historical matching information, and the historical matching information is obtained by obtaining data of historical activity records of the first user, determining whether a target first user having performed a preset operation on the first business object performs, within a preset time period associated with performing the preset operation, the preset operation on a certain business object, and aggregating a result of the determining to determine a first matching object set that the first user has selected for the first business object, and wherein determining the matching degree information between the second business object and the first business object based on the respective property information of the second business object and the first business object with respect to the corresponding dimension comprises: determining whether the second business object exists in the first matching object set, and determining the matching degree information of the second business object and the first business object based on a determination result.

Clause 10: The method of Clause 9, wherein the historical matching information is obtained by: obtaining an exemplary matching proposal and determining identifiers of business objects corresponding to single items in the matching proposal; and determining a second matching object set of the first business object in the exemplary matching proposal, wherein determining the matching degree information between the second business object and the first business object based on the respective property information of the second business object and the first business object with respect to the corresponding dimension comprises: determining whether the second business object appears in the second matching object set, and determining the matching degree information of the second business object and the first business object based on a determination result.

Clause 11: The method of Clause 10, wherein obtaining the exemplary matching proposal comprises obtaining the exemplary matching proposal based on matching information submitted by a second user.

Clause 12: The method of Clause 10, wherein obtaining the exemplary matching proposal and determining the identifiers of the business objects corresponding to the single items in the matching proposal comprise: obtaining an exemplary matching image; and identifying the identifiers of thee business objects corresponding to the single items that form the matching proposal in the image.

Clause 13: The method of Clause 12, further comprising: determining business objects having same or similar designs of the single items after individually determining the identifiers of the business objects corresponding to the single items; and forming a plurality of exemplary matching proposals based on the identifiers of the business objects corresponding to the single items and identifiers of the business objects having same or similar designs of the single items.

Clause 14: The method of Clause 1, wherein determining the matching degree information between the second business object and the first business object based on the respective property information of the second business object and the first business object with respect to the corresponding dimension comprises: determining scores of degrees of matching between the second business object and the first business object with respect to various dimensions; and determining a sum of the scores with respect to the various dimensions as the matching degree information of the second business object and the first business object.

Clause 15: The method of Clause 1, wherein prior to determining the at least one second business object, the method further comprises: determining whether the matching information database includes a matching proposal corresponding to a same design or a similar design of the first business object; and triggering to perform determining the at least one second business object that is selectable when matching the first business object and subsequent operations if not included.

Clause 16: The method of Clause 1, further comprising: performing statistics on information about situations of matching proposals being effectively used in a process of providing the matching proposals to buyers according to the matching information database; and adjusting the matching proposals in the matching information database based on a statistical result.

Clause 17: The method of Clause 1, further comprising storing property tags of the matching proposal in the matching information database, the property tags being used for describing one or more items of the following items: a style, a price, a suitable wearing occasion, or a group associated with the matching proposal.

Clause 18: The method of Clause 1, further comprising storing identifier information of stores to which the first business object and the second business object respectively belong.

Clause 19: A method for providing matching information of a business object, comprising: pre-establishing a matching information database of business objects of a fashion category by a server, the matching information database storing respective one or more matching proposals corresponding to first business objects, and the matching proposals including respective second business objects that matches with the first business objects and corresponding matching degree information; receiving a request for obtaining matching information of a specific first business object from a client of a first user; and providing information of a matching proposal of the specific first business object according to the matching information database.

Clause 20: The method of Clause 19, wherein the request includes information of an access source, and providing the information of the matching proposal of the specific first business object according to the matching information database comprises: selecting a matching mode based on the access source; and providing the information of the matching proposal of the specific first business object based on the matching mode and the matching information database.

Clause 21: The method of Clause 20, wherein: the access source comprises a details page of the specific first business object or a home page of a store, the matching information database further stores identifier information of stores to which the first business object and the second business object respectively belong, selecting the matching mode based on the access source comprises selecting a first matching mode based on the access source, the first matching mode as selecting a matching proposal from a store to which the first business object belongs, and providing the information of the matching proposal of the specific first business object based on the matching mode and the matching information database comprises: determining a target matching proposal set corresponding to the specific first business object from the matching information database; and selecting a target matching proposal having a same store from the target matching proposal set based on the first matching mode, and providing the target matching proposal to the client of the first user.

Clause 22: The method of Clause 20, wherein: the access source comprises a home page of a channel, a page of a collection list including the specific first business object, or a page of an order list of transactions including the specific first business object, selecting a second matching mode based on the access source, the second matching mode as providing a matching proposal across stores, and providing the information of the matching proposal of the specific first business object based on the matching mode and the matching information database comprises: determining a target matching proposal set corresponding to the specific first business object from the matching information database based on the second matching mode, and providing the target matching proposal set to the client of the first user.

Clause 23: The method of Clause 20, wherein the access resource comprises a home page of a store, and prior to receiving the request for obtaining the matching information of the specific first business object sent from the client of the first user, the method further comprises: providing recommended matching proposals of the store to the client of the first user according to the matching information database, to enable the client of the first user to provide the recommended matching proposals to the first user, and determine a single item as the specific first business object when the first user locks the single item in a certain matching proposal, and send the request for obtaining the matching information of the specific first business object to the server.

Clause 24: The method of Clause 20, wherein: the matching information database further stores property tags of the matching proposal, and the property tags being used for describing one or more items of the following items: a style, a price, a suitable wearing occasion or group associated with the matching proposal, when the access source is a home page of a fashion channel, the method further comprises: determining property tags of a matching proposal needed by the first user before the request for obtaining the matching information of the specific first business object is received from the client of the first user; and providing matching proposals matching the property tags to the client of the first user, to enable the client of the first user to provide the matching proposals to the first user, determine a single item as the specific first business object when the first user locks the single item in a certain matching proposal, and send the request for obtaining the matching information of the specific first business object to the server.

Clause 25: The method of Clause 24, wherein determining the property tags of the matching proposal needed by the first user comprises determining the property tags of the matching proposal needed based on user characteristics of the first user and/or preference information of fashion matching that are known in advance.

Clause 26: The method of Clause 24, wherein determining the property tags of the matching proposal needed by the first user comprises determining the property tags of the matching proposal needed based on property tags that are specified by the first user and submitted by the client of the first user.

Clause 27: The method of Clause 19, wherein providing the information of the matching proposal of the specific first business object according to the matching information database comprises: determining personalized information of the first user when the business object is selected; and providing the matching proposal corresponding to the specific first business object according to the personalized information and the matching information database.

Clause 28: The method of Clause 19, further comprising providing information of images showing matching effects of a plurality of matching proposals when the matching proposal information of the specific first business object is provided.

Clause 29: The method of Clause 28, wherein providing the information of the images showing the matching effects of the plurality of matching proposals comprises: sending information of identifiers of the first business object and second business objects included in the plurality of matching proposals to an image synthesis server, to cause the image synthesis server to determine respective stereo images of the first business object and the second business objects using a pre-stored image database, and use the respective stereo images and a preconfigured human model to form the images showing the matching effects for returning; and providing the images showing the matching effects that are returned by the image synthesis server to the client of the first user.

Clause 30: The method of Clause 28, wherein providing the information of the images showing the matching effects of the plurality of matching proposals comprises: determining stereo images of the first business object and second business objects included in the plurality of matching proposals; and providing the stereo images to the client of the first user, to enable the client of the first user to use the stereo images and a preconfigured human model to form the images showing the matching effects.

Clause 31: The method of Clause 19, further comprising providing link information of a details page of a second business object included in the matching proposal when the matching proposal of the specific first business object is provided.

Clause 32: The method of Clause 19, further comprising: providing an option of operation for saving the matching proposal information in a collection; and adding information of a specific matching proposal into a collection list in response to receiving a request for saving the specific matching proposal from the first user through the option of operation.

Clause 33: The method of Clause 19, further comprising: providing an option of operation for sharing the matching proposal; and sending information of a specific matching proposal to a preset target first user in response to receiving a request for sharing the specific matching proposal from the first user through the option of operation.

Clause 34: The method of Clause 33, further comprising monitoring operations of the target first user who receives shared information on the matching proposal, to help performing statistics on information about a use efficiency of the matching proposal information.

Clause 35: A method for providing matching information of a business object, comprising: receiving a request for obtaining matching information of a specific first business object by a client of a first user; transmitting the request to a server, to enable the server to return matching proposal information of the specific first business object according to a pre-established matching information database, wherein the matching information database stores at least one matching proposal of the first business object, and the matching proposal includes a second business object that matches the first business object and matching degree information; and providing the matching proposal information of the specific first business object according to response information returned from the server.

Clause 36: The method of Clause 35, wherein receiving the request for obtaining the matching information of the specific first business object comprises receiving the request for obtaining the matching information of the specific first business object through a details page of the specific first business object, a page of a collection list including the specific first business object, or a page of an order list of transactions including the specific first business object.

Clause 37: The method of claim 35, wherein receiving the request for obtaining the matching information of the specific first business object comprises: receiving the request for obtaining the matching information through a home page of a store or a home page of a fashion channel; sending a request for obtaining at least one recommended matching proposal to the server; and determining a single item as the specific first business object when the single item in a certain recommended matching proposal is locked, and triggering to send the request for obtaining the matching information of the specific first business object to the server.

Clause 38: The method of Clause 37, wherein the response information returned from the server further comprises respective stereo images corresponding to the first business object and a second business object in the matching proposal, and the method further comprises using the stereo images and a preconfigured human model to form an image showing a matching effect.

Clause 39: The method of Clause 38, further comprising switching between stereo images of second business objects in the image showing the matching effect based on a request for switching operation when a number of matching proposals are returned by the server.

Clause 40: The method of Clause 35, further comprising providing matching proposals, based on categories to which respective second business objects in the matching proposals belong, according to the categories when a number of the matching proposals returned by the server is more than one.

Clause 41: A method for providing matching information of a business object, comprising: receiving a request for obtaining matching information of a specific first business object from a client of a first user by a server; determining at least one information dimension that is referable when matching with the first business object; determining matching degree information of the second business object and the first business object based on respective property information of the second business object and the first business object with respect to a corresponding dimension; and providing matching proposal information of the specific first business object based on the matching proposal information.

Clause 42: A method for providing matching information of a business object, comprising: receiving a request for obtaining matching information of a specific first business object by a client of a first user; transmitting the request to a server, to enable the server to determine at least one second business object that is selectable when the first business object is matched, determine at least one information dimension that is referable when the first business object is matched, determiner matching degree information between the second business object and the first business object based on respective property information of the second business object and the first business object on a corresponding dimension, and provide matching proposal information of the specific first business object based on the matching degree information; and providing the matching proposal information of the specific first business object based on response information returned from the server.

Clause 43: An apparatus for establishing a matching information database, comprising: a selectable business object determination unit used for determining at least one second business object that is selectable when matching a first business object; an information dimension determination unit used for determining at least one information dimension that is referable when matching the first business object; a matching degree determination unit used for determining matching degree information between the second business object and the first business object based on respective property information of the second business object and the first business object on a corresponding dimension; and a matching proposal generation unit used for generating at least one matching proposal corresponding the first business subject, and storing thereof in the matching information database, the matching proposal including a second business object that matches the first business object and corresponding matching degree information.

Clause 44: The apparatus of Clause 43, wherein the referable information dimension comprises a specification parameter of the first business object, and the information dimension determination unit is used for determining the matching degree information between the second business object and the first business object based on respective property information of the second business object and the first business object on dimensions of specification parameters.

Clause 45: The apparatus of Clause 44, wherein the matching degree determination unit comprises: a dimension individual determination subunit used for separately determining degrees of matching between the second business object and the first business object on the dimensions based on preset matching rule information for the dimensions of specification parameters; and a combination determination subunit used for combining the degrees of matching with the first business object on the dimensions to determine the matching degree information of the second business object and the first business object.

Clause 46: The apparatus of Clause 43, wherein the referable information dimension comprises historical matching information, and the historical matching information is obtained by: an activity data acquisition unit used for obtaining data of historical activity records of the first user; an activity data determination unit used for determining whether a target first user having performed a preset operation on the first business object performs, within a preset time period associated with performing the preset operation, the preset operation on a certain business object; and a collection unit used for aggregating results of the determining to determine a first matching object set that the first user has selected for the first business object, wherein the matching degree determination unit is used for determining whether the second business object exists in the first matching object set, and determining the matching degree information of the second business object and the first business object based on a determination result.

Clause 47: The apparatus of Clause 46, wherein the historical matching information is obtained by: an exemplary matching proposal acquisition unit used for obtaining an exemplary matching proposal and determining identifiers of business objects corresponding to single items in the matching proposal; and a set determination unit used for determining a second matching object set of the first business object in the exemplary matching proposal, wherein the matching degree determination unit is used for determining whether the second business object appears in the second matching object set, and determining the matching degree information of the second business object and the first business object based on a determination result.

Clause 48: The apparatus of Clause 47, wherein the exemplary matching proposal acquisition unit comprises a first acquisition subunit used for obtaining the exemplary matching proposal based on matching information submitted by a second user.

Clause 49: The apparatus of Clause 47, wherein the exemplary matching proposal acquisition unit comprises: an image acquisition subunit used for obtaining an exemplary matching image; and an identifying subunit used for identifying identifiers of business objects corresponding to single items that form the matching proposal in the image.

Clause 50: The apparatus of Clause 43, wherein the matching degree determination unit comprises: a score determination subunit used for determining scores of degrees of matching between the second business object and the first business object with respect to various dimensions; and a score combination subunit used for determining a sum of the scores with respect to the various dimensions as the matching degree information of the second business object and the first business object.

Clause 51: The apparatus of Clause 43, further comprising a property tag storage unit used for storing property tags of the matching proposal in the matching information database, the property tags being used for describing one or more of the following items: a style, a price and a suitable wearing occasion, or a group associated with the matching proposal.

Clause 52: An apparatus for providing matching information of a business object, which is applied in a server, the apparatus comprising: a database creation unit used for pre-establishing a matching information database for business object of a fashion category, the matching information database storing at least one matching proposal corresponding to a first business object, and the matching proposal including second business object that can match with the first business object and matching degree information; a request receiving unit used for receiving a request for obtaining matching information of a specific first business object sent from a client of a first user; and a matching proposal provision unit used for providing matching proposal information of the specific first business object according to the matching information database.

Clause 53: The apparatus of Clause 52, wherein the request includes information of an access source, and the matching proposal provision unit comprises: a matching mode determination subunit used for selecting a matching mode for the access source; and a matching proposal determination subunit used for providing the matching proposal information of the specific first business object according to the matching mode and the matching information database.

Clause 54: The apparatus of Clause 53, wherein: the access source comprises a details page of the specific first business object or a home page of a store, the matching information database further stores identifier information of stores to which the first business object and the second business object respectively belong, the matching mode determination subunit is used for selecting a first matching mode based on the access source, the first matching mode as selecting a matching proposal from a store to which the first business object belongs, and the matching proposal determination subunit comprises: a target set determination subunit used for determining a target matching proposal set corresponding to the specific first business object from the matching information database; and a selection subunit used for selecting a target matching proposal having a same store from the target matching proposal set based on the first matching mode, and providing the target matching proposal to the client of the first user.

Clause 55: The apparatus of Clause 53, wherein: the access source comprises a home page of a channel, a page of a collection list including the specific first business object, or a page of an order list of transactions including the specific first business object, the matching proposal determination subunit is used for selecting a second matching mode based on the access source, the second matching mode as providing a matching proposal across stores, and the matching proposal determination subunit is used for determining a target matching proposal set corresponding to the specific first business object from the matching information database based on the second matching mode, and providing the target matching proposal set to the client of the first user.

Clause 56: The apparatus of Clause 53, wherein: when the access resource comprises a home page of a store, the apparatus further comprises: a first recommended matching proposal provision unit used for providing recommended matching proposals of the store to the client of the first user according to the matching information database before receiving the request for obtaining the matching information of the specific first business object sent from the client of the first user, to enable the client of the first user to provide the recommended matching proposals to the first user, and determine a single item as the specific first business object when the first user locks the single item in a certain matching proposal, and send the request for obtaining the matching information of the specific first business object to the server.

Clause 57: The apparatus of Clause 53, wherein: the matching information database further stores property tags of the matching proposal, the property tags being used for describing one or more items of the following items: a style, a price, a suitable wearing occasion, or a group associated with the matching proposal, and when the access source is a home page of a fashion channel, the apparatus further comprises: a property tag determination unit used for determining property tags of a matching proposal needed by the first user before the request for obtaining the matching information of the specific first business object is received from the client of the first user; and a second recommended matching proposal provision unit used for providing matching proposals matching the property tags to the client of the first user, to enable the client of the first user to provide the matching proposals to the first user, determine a single item as the specific first business object when the first user locks the single item in a certain matching proposal, and send the request for obtaining the matching information of the specific first business object to the server.

Clause 58: The apparatus of Clause 57, wherein the property tag determination unit comprises a first tag determination subunit used for determining the property tags of the matching proposal needed based on user characteristics of the first user and/or preference information of fashion matching that are known in advance.

Clause 59: The apparatus of Clause 57, wherein the property tag determination unit comprises a second tag determination subunit used for determining the property tags of the matching proposal needed based on property tags that are specified by the first user and submitted by the client of the first user.

Clause 60: The apparatus of Clause 52, wherein the matching proposal provision unit comprises: a personalized information determination subunit used for determining personalized information of the first user when a business object is selected; and a proposal provision subunit used for providing the matching proposal corresponding to the specific first business object according to the personalized information and the matching information database.

Clause 61: The apparatus of Clause 52, further comprising an image information provision unit used for providing information of images showing matching effects of various matching proposals when the matching proposal information of the specific first business object is provided.

Clause 62: The apparatus of Clause 61, wherein the image information provision unit comprises: an identifier sending subunit used for sending information of identifiers of the first business object and second business objects included in the matching proposals to an image synthesis server, to cause the image synthesis server to determine respective stereo images of the first business object and the second business objects using a pre-stored image database, and use the respective stereo images and a preconfigured human model to form the images showing the matching effects for returning; and a matching effect display image provision unit used for providing the images showing the matching effects that are returned by the image synthesis server to the client of the first user.

Clause 63: The apparatus of Clause 61, wherein the image information provision unit comprises: a stereo image determination subunit used for determining stereo images of the first business object and second business objects included in the various matching proposals; and a stereo image provision subunit used for providing the stereo images to the client of the first user, to enable the client of the first user to use the stereo images and a preconfigured human model to form the images showing the matching effects.

Clause 64: The apparatus of Clause 52, further comprising a details page link information provision unit used for providing link information of a details page of a second business object included in the matching proposal when the matching proposal of the specific first business object is provided.

Clause 65: The apparatus of Clause 52, further comprising: a collection operation option provision unit used for providing an option of operation for saving the matching proposal information in a collection; and a collection unit used for adding information of a specific matching proposal into a collection list in response to receiving a request for saving the specific matching proposal from the first user through the option of operation.

Clause 66: The apparatus of Clause 52, further comprising: a sharing operation option provision unit used for providing an option of operation for sharing the matching proposal; and a sharing unit used for sending information of a specific matching proposal to a preset target first user in response to receiving a request for sharing the specific matching proposal from the first user through the option of operation.

Clause 67: An apparatus for providing matching information of a business object, which is applied in a client of a first user, the apparatus comprising: a first matching request receiving unit used for receiving a request for obtaining matching information of a specific first business object; a first matching request transmission unit used for transmitting the request to a server, to enable the server to return matching proposal information of the specific first business object according to a pre-established matching information database, the matching information database storing respective one or more matching proposals of first business objects, and the respective matching proposals storing respective second business objects that can match with the first business objects, and respective matching degree information; and a first matching proposal provision unit used for providing the matching proposal information of the specific first business object based on response information returned by the server.

Clause 68: The apparatus of Clause 67, wherein the first matching request receiving unit comprises a first receiving subunit used for receiving the request for obtaining the matching information of the specific first business object through a details page of the specific first business object, a page of a collection list including the specific first business object, or a page of an order list of transactions including the specific first business object.

Clause 69: The apparatus of Clause 67, wherein the first matching request receiving unit comprises: a second receiving subunit used for receiving the request for obtaining the matching information through a home page of a store or a home page of a fashion channel; a recommendation matching request subunit used for sending a request for obtaining at least one recommended matching proposal to the server; and a specified business object determination subunit used for determining a single item as the specific first business object when the single item in a certain recommended matching proposal is locked, and triggering to send the request for obtaining the matching information of the specific first business object to the server.

Clause 70: The apparatus of Clause 67, wherein the response information returned by the server also includes respective stereo images corresponding to the first business object and second business objects in the matching proposal, and the apparatus further comprises an image synthesis unit used for using the stereo images and a preconfigured human model to form images showing matching effects.

Clause 71: An apparatus for providing matching information of a business object, which is applied in a server, the apparatus comprising: a request receiving unit used for receiving a request for obtaining matching information of a specific first business object sent from a client of a first user; a business object determination unit used for determining at least one business object that is selectable when the first business object is matched; an information dimension determination unit used for determining at least one information dimension that is referable when the first business object is matched; a matching degree information determination unit used for determining matching degree information of the second business object and the first business object based on property information of the second business object and the first business object with respect to a corresponding dimension; and a matching proposal provision unit used for providing matching proposal information of the specific first business object based on the matching degree information.

Clause 72: An apparatus for providing matching information of a business object, which is applied in a client of a first user, the apparatus comprising: a second matching request receiving unit used for receiving a request for obtaining matching information of a specific first business object; a second matching request transmission unit used for transmitting the request to a server, to cause the server to determine at least one second business object that is selectable when matching the first business object, determine at least one information dimension that is referable when matching the first business object, determine matching degree information between the second business subject and the first business object based on property information of the second business object and the first business object with respect to a corresponding dimension, and provide matching proposal information of the specific first business object based on the matching degree information; and a second matching proposal provision unit used for providing the matching proposal information of the specific first business object based on response information returned by the server.

1. A method comprising:
determining one or more second business objects that are selectable when matching a first business object;
determining one or more information dimensions that are referable when matching the first business object;
determining matching degree information between the one or more second business objects and the first business object based on respective property information of the one or more second business objects and the first business object with respect to the one or more information dimensions; and
generating and storing one or more matching proposals corresponding to the first business object in a matching information database, the one or more matching proposals including respective second business objects that matches the first business object and respective matching degree information.

2. The method of claim 1, wherein determining the one or more second business objects that are selectable comprises determining the one or more second business objects based on preset category matching information and a category to which the first business object belongs.

3. The method of claim 1, wherein the one or more information dimensions that are referable include a specification parameter of the first business object, and determining the matching degree information between the one or more second business objects and the first business object comprises determining the matching degree information between the one or more second business objects and the first business object based on respective specification parameter information of the one or more second business objects and the first business object with respect to the one or more information dimensions.

4. The method of claim 3, wherein determining the matching degree information between the one or more second business objects and the first business object based on the respective specification parameter information of the one or more second business objects and the first business object with respect to the one or more information dimensions comprises:
separately determining degrees of matching between the one or more second business objects and the first business object with respect to dimensions of specification parameters based on information of preset matching rules for the one or more information dimensions; and
combining the degrees of matching to determine the matching degree information of the one or more second business objects and the first business object.

5. The method of claim 1, wherein the one or more information dimensions that are referable include historical matching information, and the method further comprises obtaining historical matching information by:
obtaining data of historical activity records of one or more target users,
determining whether the one or more target users having performed a preset operation on the first business object perform, within a preset time period when the preset operation is performed, the preset operation on another business object, and
aggregating a result of the determining to determine a first matching object set that the one or more target users have selected for the first business object.

6. The method of claim 5, wherein determining the matching degree information between the one or more second business objects and the first business object comprises:
determining whether the one or more second business objects exist in the first matching object set, and
determining the matching degree information of the one or more second business objects and the first business object based on a determination result.

7. The method of claim 1, wherein the one or more information dimensions that are referable include historical matching information, and the method further comprises obtaining historical matching information by:
obtaining an exemplary matching proposal and determining identifiers of business objects corresponding to single items in the exemplary matching proposal; and
determining a second matching object set of the first business object in the exemplary matching proposal, wherein determining the matching degree information between the one or more second business objects and the first business object comprises:
determining whether the one or more second business objects appear in the second matching object set, and
determining the matching degree information of the one or more second business objects and the first business object based on a determination result.

8. The method of claim 7, wherein obtaining the exemplary matching proposal and determining the identifiers of the business objects corresponding to the single items in the matching proposal comprise:
obtaining an exemplary matching image; and
identifying the identifiers of thee business objects corresponding to the single items that form the matching proposal in the exemplary matching image.

9. The method of claim 1, further comprising:
performing statistics on information about situations of the one or more matching proposals being used in a process of providing the one or more matching proposals to one or more users according to the matching information database; and
adjusting the one or more matching proposals in the matching information database based on a statistical result.

10. One or more computer-readable media storing executable instructions that, when executed by one or more processors, cause the one or more processors of a server to perform acts comprising:
pre-establishing a matching information database of business objects, the matching information database storing a plurality of matching proposals corresponding to a plurality of first business objects, and each of the plurality of matching proposals including respective one or more second business objects that matches with a respective first business object and corresponding matching degree information;
receiving a request for obtaining matching information of a specific first business object from a client of a first user; and
providing information of one or more matching proposals of the specific first business object according to the matching information database.

11. The one or more computer-readable media of claim 10, wherein the request includes information of an access source, and providing the information of the one or more matching proposals of the specific first business object according to the matching information database comprises:
selecting a matching mode based on the access source; and
providing the information of the one or more matching proposals of the specific first business object based on the matching mode and the matching information database.

12. The one or more computer-readable media of claim 10, wherein providing the information of the one or more matching proposals of the specific first business object according to the matching information database comprises:
determining personalized information of the first user when the business object is selected; and
providing the one or more matching proposals corresponding to the specific first business object according to the personalized information and the matching information database.

13. The one or more computer-readable media of claim 10, the acts further comprising providing information of images showing matching effects of the one or more matching proposals.

14. The one or more computer-readable media of claim 13, wherein providing the information of the images showing the matching effects of the one or more matching proposals comprises:
sending information of identifiers of the first business object and respective one or more second business objects included in the one or more matching proposals to an image synthesis server, to cause the image synthesis server to determine corresponding stereo images of the first business object and the one or more second business objects using a pre-stored image database, and use the corresponding stereo images and a preconfigured human model to form the images showing the matching effects for returning; and
providing the images showing the matching effects that are returned by the image synthesis server to the client of the first user.

15. The one or more computer-readable media of claim 10, the acts further comprising:
providing an option of operation for saving matching proposal information in a collection; and
adding information of a specific matching proposal into a collection list in response to receiving a request for saving the specific matching proposal from the first user through the option of operation.

16. The one or more computer-readable media of claim 10, the acts further comprising:
providing an option of operation for sharing the matching proposal; and
sending information of a specific matching proposal to a preset target first user in response to receiving a request for sharing the specific matching proposal from the first user through the option of operation.

17. An apparatus comprising:
one or more processors;
memory;
a first matching request receiving unit stored in the memory and executable by the one or more processors to receive a request for obtaining matching information of a specific first business object;
a first matching request transmission unit stored in the memory and executable by the one or more processors to transmit the request to a server, to enable the server to return matching proposal information of the specific first business object according to a pre-established matching information database, the matching information database storing respective one or more matching proposals of first business objects, and the respective matching proposals storing respective second business objects that can match with the first business objects, and respective matching degree information; and
a first matching proposal provision unit stored in the memory and executable by the one or more processors to provide the matching proposal information of the specific first business object based on response information returned by the server.

18. The apparatus of claim 17, wherein the first matching request receiving unit comprises a first receiving subunit to receive the request for obtaining the matching information of the specific first business object through a details page of the specific first business object, a page of a collection list including the specific first business object, or a page of an order list of transactions including the specific first business object.

19. The apparatus of claim 17, wherein the first matching request receiving unit comprises:
a second receiving subunit used for receiving the request for obtaining the matching information through a home page of a store or a home page of a fashion channel;
a recommendation matching request subunit used for sending a request for obtaining at least one recommended matching proposal to the server; and
a specified business object determination subunit used for determining a single item as the specific first business object when the single item in a certain recommended matching proposal is locked, and triggering to send the request for obtaining the matching information of the specific first business object to the server.

20. The apparatus of claim 17, wherein the response information returned by the server also includes respective stereo images corresponding to the first business object and second business objects in the matching proposal, and the apparatus further comprises an image synthesis unit used for using the stereo images and a preconfigured human model to form images showing matching effects.
